(19) United States
(12) Patent Application Publication
(10) Pub. No.: US 2012/0068838 A1
(43) Pub. Date: Mar. 22, 2012

(54) Bariatric Patient Lift Apparatus

(76) Inventor: Robert John Ein, Lexington, KY (US)

(21) Appl. No.: 13/199,457

(22) Filed: Aug. 31, 2011

Related U.S. Application Data
(60) Provisional application No. 61/402,676, filed on Sep. 2, 2010.

(51) Int. Cl. B60Q 1/00; A61G 7/10

(52) U.S. Cl. 340/435; 5/83.1; 5/86.1

(57) ABSTRACT

There are many types of bariatric lift apparatuses. Some of the present designs are inherently unstable in nature because of their basic design philosophy. Others are extremely large and bulky and can not be used effectively in the bariatric patient's living quarters. In others there is inability to transfer bariatric patients from certain type of beds or other furniture items because the devices contain certain obstacles which are inherent to their design. One of the functions of the apparatus is to provide controlled unassisted transfer from the bed to the apparatus. The inability of some bariatric patients to provide any self induced lifting in a normal manner is a major limiting feature of present-day gurney and/or lift chair designs. As the obesity rate climbs nationwide, obese and morbidly obese patients will continue to pose special lifting challenges to the healthcare industry.

### FIELD OF SEARCH

5/81 R; 5/81.1: 5/81.1RP; 5/83.1; 5/86.1; 5/87.1; 5/89.1; 177/144 and 254/8 R

References Cited
US PATENT DOCUMENTS

| | | | |
|---|---|---|---|
| 2,375,907 | May 15, 1945 | Farmer | 5/86.1 |
| 3,629,880 | Dec. 28, 1971 | van Rhyn | 5/83.1 |
| 3,931,956 | Jan. 13, 1976 | Hawkins | 254/8 R |
| 4,680,819 | Jul. 21, 1987 | James | 5/83.1 |
| 4,682,377 | Jul. 28, 1987 | Reich | 5/83.1 |
| 4,703,523 | Nov. 03, 1987 | James | 5/83.1 |
| 4,918,771 | Apr. 24, 1990 | James | 5/87.1 |
| 5,022,106 | Jun. 11, 1991 | Richards | 5/86.1 |
| 5,148,559 | Sep. 22, 1992 | Morris | 5/86.1 |
| 5,257,425 | Nov. 02, 1993 | Shinabarger | 5/81.1 |
| 5,309,584 | May 10, 1994 | Parker | 5/81.1 |
| 5,365,621 | Nov. 22, 1994 | Blain | 5/81.1 |
| 5,369,821 | Dec. 06, 1994 | Richards et al. | 5/86.1 |
| 5,412,820 | May 09, 1995 | Richards | 5/86.1 |
| 5,526,541 | Jun. 18, 1996 | Massey et al. | 5/81.1 |
| 5,530,976 | Jul. 02, 1996 | Horcher | 5/89.1 |
| 5,560,054 | Nov. 01, 1996 | Simon | 5/86.1 |
| 5,644,805 | Jul. 08, 1997 | Horcher | 5/86.1 |
| 5,682,630 | Nov. 04, 1997 | Simon | 5/87.1 |
| 5,878,450 | Mar. 09, 1999 | Bouhuijs | 5/86.1 |
| 5,892,180 | Apr. 06, 1999 | Carey | 177/144 |
| 6,092,247 | Jul. 25, 2000 | Wilson | 5/86.1 |
| 6,119,287 | Sep. 19, 2000 | Phillips | 5/81.1RP |
| 6,134,725 | Oct. 24, 2000 | Bouhuijs | 5/86.1 |
| 6,175,973 | Jan. 23, 2001 | Hakamiun et al. | 5/89.1 |
| 6,329,612 | Dec. 11, 2001 | von Schroeter | 177/144 |
| 6,367,103 | Apr. 09, 2002 | Collins | 5/86.1 |
| 6,389,619 | May 21, 2002 | Dunn | 5/86.1 |
| 6,430,761 | Aug. 13, 2002 | Brandorff et al. | 5/86.1 |
| 6,449,785 | Sep. 17, 2002 | Liljedahl | 5/89.1 |
| 6,557,189 | May 06, 2003 | Von Schroeter | 5/86.1 |
| 6,568,002 | May 27, 2003 | Liljedahl | 5/86.1 |
| 6,581,222 | Jun. 24, 2003 | Liljedahl | 5/89.1 |
| 6,665,894 | Dec. 23, 2003 | Moffa et al. | 5/86.1 |
| 6,718,573 | Apr. 13, 2004 | Von Schroeter | 5/86.1 |
| 6,857,144 | Feb. 22, 2005 | Huang | 5/86.1 |
| 7,020,913 | Apr. 04, 2006 | Van Scheppingen et al. | 5/86.1 |
| 7,346,941 | Mar. 25, 2008 | Ein | 5/83.1 |
| 7,634,824 | Jun. 29, 2006 | Gramkow et al. | 5/81 R |
| 7,690,056 | Sep. 29, 2005 | Moffa et al. | 5/84.1 |

This application claims the benefit of U.S. Provisional Application No. 61/402,676 filed Sep. 2, 2010, incorporated by reference herein in its entirety.

### BACKGROUND OF THE INVENTION

1. Technical Field

This invention relates to a portable patient lift apparatus for use by humans. More specifically, this invention relates to a portable lifting apparatus for assisting in lifting obese individuals in and out of a hospital bed or other locations and then transporting them to a different location.

Nursing staffs have the highest incidences of work-relate back problems of any occupation. The incidence rate continues to climb. Work-related musculoskeletal disorders (MSDs) account for a major portion of the cost of work-related injuries in the United States. A contributing factor is the fact that the American population has become one of the most overweight in the world. Nearly 97 million American adults are overweight. Of the 97 million overweight American adults, it is estimated that 4 million are severely obese [Body Mass Index {BMI}>35 and 1.5 million [BMI>40] are morbidly obese.

With these rising numbers of severely and morbidly obese individuals come numerous complications relating to medical treatment. Besides the cost issue, healthcare providers must consider the daunting safety implications for both the patient and caregiver. One specific problem lies in simply providing a means for these patients to be able to rise or sit on the hospital bed or other locations without the risk of harm to the patient and/or the caregiver performing this task.

The movement of bariatric patients (a medical term derived from the Greek word “baros” meaning weight) produces special challenges to health care professionals. Internationally, a bariatric patient is defined as an individual that has a BMI>30. Many studies have shown that health care workers are at the greatest risk for musculoskeletal injuries when dealing with bariatric patients, particularly in the sit-to-stand transfer mode. The best way to ensure safe patient handling is through the use of specialized mechanical equipment that is designed to meet the size and weight requirements of the bariatric patient.

One of the main benefits of the apparatus is that it requires only a single person to perform the sit-to-stand transfer function of the bariatric patient, which in turn will reduce the resources expended to perform this task.

2. Description of the Prior Art

There are many types of mechanical lift mechanisms on the market for bariatric patient lifting. Some of the present designs are inherently unstable in nature because of their basic design philosophy. Others are extremely large and bulky and can not be used effectively in the bariatric patient's room. In others, the inability to transfer bariatric patients from certain types of wheelchairs or other assistive items because they contain certain obstacles is inherent to their design. One of the functions of the apparatus is to provide controlled unassisted lifting movement for the user. The inability of some bariatric patients to provide any self induced lifting in a normal manner without the chance of a fall is a major limiting feature of present mechanical lift device designs.

There are at least 6 types of mechanical lift mechanisms on the market today. They range from the following: 1) Powered Hospital bed that converts to a chair (known as a Total Care Bed System®); 2) Permanently mounted powered ceiling system; 3) Permanently mounted powered wall system; 4) A mobile powered sling lift mechanical device; 5) Mobile powered lift/stand mechanical device; and 6) Powered Standing Frame mechanical device. However, each of these types has at least one major deficiency.

The majority of the lift systems are some type of a sling mechanism. The sling is subject to several types of failures. The FDA has reported that there have been more than 50 deaths and over 500 patients have been seriously hurt because of failure of sling type lift systems. The following is summation of failures that caused death or severe injuries: 1) The patient fell to the floor when the strap that attaches the sling to the lifting frame failed; 2) The patient fell to the floor when the gravity-activated locking clip which holds the strap to the lifting frame failed; 3) The patient fell to the floor because of the patient's movement within the sling allowed the sling to slip out of the spreader bar; 4) The patient fell to the floor because the sling that was used was too large for the patient; 5) The patient fell because the lifting frame failed because of excessive load; and 6) The patient fell to the floor because the lifting mechanism that raises and lowers the jib failed resulting in the sudden drop of the jib.

The ceiling lift is one of the newest types of patient lift systems and has been available in the United States for several years. The main disadvantages associated with the ceiling lift system are the installation of overhead tracks and failure and/or stoppage of the electric drive motor unit. A track must be procured and installed in each room that requires patient transfer capabilities. Room to room transfer with the ceiling lift system will be difficult. One problem is the removal of doorway headers and replacing them with some type of header assembly that will let the ceiling lift system pass from room to room but still provide privacy to the patient. Also load conditions on the ceiling and walls must be considered in the installation of this type of patient lifter.

The wall mounted lift system is similar to the ceiling lift system except the lifting motor unit is attached to a wall mounted jib rather than a track. The main disadvantages associated with the wall mounted lift system are the limited transfer range and failure and/or stoppage of the electric drive motor unit.

The powered mobile sling lift system also known as the Hoyer style lifter is the most commonly used. The main disadvantages associated with the powered mobile sling lift system are the ability of the caregiver to maneuver the lifter once a patient is loaded into the sling, failure of the jib mechanism and/or failure and/or stoppage of the electric lift motor unit.

A major problem with the use of any sling lift system is the fact that the patient requires a lift team (two or more caregivers who are trained in proper lifting techniques) to move the bariatric patient on to and off the sling. Another problem is to provide the necessary force to move the lift mechanism to the desired location. To instruct the patient to remain motionless while being lifted to reduce the chance of lift mechanism instability is another concern.

The powered mobile sit/stand system differs from the three previous mentioned lift systems in the fact that the patient must be cognitive and provide some cooperative effort in the lifting task. The patient must possess some muscle tone in at least one lower limb, trunk and at least one upper limb. The main disadvantages associated with the mobile sit/stand system are the clearance required for the legs and/or maneuver the lifter once the patient is loaded on the lifter.

The powered standing frame system is similar to the mobile sit/stand system but it provides for a work area so that the patient can perform various tasks while standing without the fear of falling. The main disadvantages associated with the powered standing frame system are the ability of the caregiver to maneuver the system once a patient is standing in the device, failure of the control mechanism and/or failure and/or stoppage of the electric lift motor unit.

As mentioned above the Total Care Bed System® is not a lifting mechanism per se, it only positions the patient from a prone to sitting position but does not lift the patient out of the bed and transfer the patient to a new location.

### SUMMARY OF THE INVENTION

Presently there are many techniques for providing maximum structural capabilities to patient lifting system designs. These patient lifting system designs have inherent deficiencies because of limited stability, mobility, space and ruggedness required in their use. The inability to acquire stress analysis data from these patient lifting system designs in a natural surrounding introduces some distortion in the data acquired and its interpretation of the data as a result of their inherent designs. In some cases it requires the tester to use cumbersome hardware and/or testing harness(s) in order to obtain the desired data for evaluation.

One of the unique features of this patient lifting system is that it allows the patient to maintain or increase muscle tone, range of motion and possibly optimize blood flow in their extremities.

The apparatus uses a specialized drive wheel set to negotiate around various restrictive areas. The apparatus has steering and drive wheel(s), which are microprocessor controlled. In the storage mode the apparatus collapses into a small mobile module that stands approximately 3 feet tall and base circumference approximately of 3 feet in diameter. When fully operational the apparatus has approximately a maximum of 6 feet in height, appendages that have approximately a maximum reach of 5 feet and a base radius of approximately 3½ feet. The entire apparatus is motorized, which can operate on internal power source or external power. The caregiver operates the entire configuration by means of a remote controller, which is connected to microprocessor via a wireless or wired datalink. This includes transformation from storage to operational mode, movement of the appendages, and movement of the apparatus to various locations. The caregiver will determine direction, speed of the apparatus and location of the various appendages so as to lift the patient from one location and transport the patient to a different location by sending the appropriate control signal(s) to the various drive units that manipulate the various appendages and/or drive wheel(s). Each power drive unit consists primarily of a drive motor, gear reduction unit, coupling mechanisms and electronic control module. Steering is accomplished by control signals generated by the caregiver to drive a reversible DC brushless motor that rotates the rear drive wheel unit to the desired alignment direction. Also, a built-in power source such as lithium, Silver-Zinc, Alkali-Zinc batteries or some other power source [such as fuel cell(s), etc.] will provide the power required for each control module and various DC brushless motors. Power drive units could also be operated by means of hydraulics or similar power source rather than DC brushless motors.

The overall apparatus is designed for ease of use, transport and storage. In designing stability into the apparatus, overall effectiveness and safety was not compromised. The stability of the apparatus is determined and measured by the center of gravity and the resistance to tip-over of the apparatus over any given terrain. The apparatus's weight plus the patient's weight upon the apparatus determines where the center of gravity will be for the apparatus. This new center of gravity and overall horizontal footprint will dictate if the apparatus will tip-over. The stability effectiveness of the apparatus is defined as the Apparatus's Stability Index (ASI). The higher the ASI, the less stable the apparatus becomes. As a general rule of thumb, a lower ASI not only equates to better stability of the apparatus but also indicates better performance on inclines, in non-stable surface (such as cracks, gap crossings, broken tiles, etc.).

From a stability perspective, the apparatus design offers the best solution for a versatile apparatus that is required to operate over diverse surfaces. This is because the design inherently provides a greater horizontal area (footprint) projection than standard mobile patient lift designs, resulting in a lower ASI. The design incorporates a very low ASI and uses weight reduction techniques such as hybrid composite materials. Size constraints were imposed during the design phase without compromise to safety. Design criteria have dictated that the overall apparatus is built for durability and safety. The apparatus's mobility will not be impacted by its traction ability over various surfaces (such as tile, cracks, gap crossings, broken tiles, etc.).

In the obese user population 14% are apple in shape where the excess body mass is located in the upper torso (above the waist) and upper extremities. The other 86% of the obese population are pear in shape where the excess body mass is located in the lower torso (below the waist) and lower extremities. The skeletal frame of the user does not change with the addition of excess body mass but does limit the motion of the individual user. To accommodate this excess body mass a throne shaped cavity is incorporated within the lower trunk unit of the apparatus. The throne shaped cavity is encapsulated by a liner that is removable and is cleanable. Rather than sit in the throne shaped cavity, the obese user stands and faces the cavity and uses the arm rests as support because an obese user will have great difficulty in raising his/her upper extremities above the shoulder level. The extreme large obese user will have great difficulties rising above the elbow level. Therefore, the user might not be able to use the lifting arm portion of the apparatus but rather use the arm rest portion of the throne shaped cavity. This throne shaped cavity provides stability to the user and minimizes potential falls from the apparatus while entering, in transit, and/or exiting. A sling and retractable seat are incorporated into the apparatus (in the extreme large obese user version) to provide necessary support and stability to the user during transition from sitting to standing configuration and from standing to sitting configuration.

### BRIEF DESCRIPTION OF THE DRAWINGS

Other objects and advantages of the present invention will become apparent from the following detailed description of the preferred embodiment of thereof taken in conjunction with the accompanying drawings, wherein:

FIG. 1a is an overall view of the invention for obese users and depicts the apparatus in is fully extended mode configuration with sling hoist output located at the side of the apparatus;

FIG. 1b is an overall view of the invention and extremely large obese users depicts the apparatus in is fully extended mode configuration with sling hoist output located at the front of the apparatus;

FIG. 2a is schematic presentations of the front view of the lower trunk unit in the obese user configuration;

FIG. 2b is schematic presentations of the left side view of the lower trunk unit in the obese user configuration;

FIG. 2c is schematic presentations of the right side view of the lower trunk unit in the obese user configuration;

FIG. 2d is schematic presentations of the back side view of the lower trunk unit in the obese user configuration;

FIG. 2e is schematic presentations of the left side view of the lower trunk unit in the extremely large obese user configuration;

FIG. 2f is schematic presentations of the right side view of the lower trunk unit in the extremely large obese user configuration;

FIG. 2g is schematic presentations of the front view of the lower trunk unit in the extremely large obese user configuration;

FIG. 2h is schematic presentations of the rear view of the lower trunk unit in the extremely large obese user configuration;

FIG. 3a is schematic presentations of the top side view of the upper trunk unit for the fixed front output dispensing cable delivery tube unit in the obese user configuration;

FIG. 3b is schematic presentations of the left side view of the upper trunk unit for the fixed front output dispensing cable delivery tube unit in the obese user configuration;

FIG. 3c is schematic presentations of the front side view of the upper trunk unit for the fixed front output dispensing cable delivery tube unit in the obese user configuration;

FIG. 3d is schematic presentations of the right side view of the upper trunk unit for the fixed front output dispensing cable delivery tube unit in the obese user configuration;

FIG. 3e is schematic presentations of the top side view of the upper trunk unit for the variable side output dispensing cable delivery tube unit in the extremely large obese user configuration;

FIG. 3f is schematic presentations of the left side view of the upper trunk unit for the variable side output dispensing cable delivery tube unit in the extremely large obese user configuration;

FIG. 3g is schematic presentations of the front side view of the upper trunk unit for the variable side output dispensing cable delivery tube unit in the extremely large obese user configuration;

FIG. 3h is schematic presentations of the right side view of the upper trunk unit for the variable side output dispensing cable delivery tube unit in the extremely large obese user configuration;

FIG. 4a is schematic presentations of the top side view of the chin/head padded support unit configuration;

FIG. 4b is schematic presentations of the left side view of the chin/head padded support unit configuration;

FIG. 4c is schematic presentations of the front side view of the chin/head padded support unit configuration;

FIG. 4d is schematic presentations of the right side view of the chin/head padded support unit configuration;

FIG. 5a is schematic presentations of the left side variable geometry stability fin unit in the obese user configuration of the invention;

FIG. 5b is schematic presentations of the right side variable geometry stability fin unit in the obese user configuration of the invention;

FIG. 5c is schematic presentations of the rear side variable geometry stability fin units in the obese user configuration of the invention;

FIG. 5d is the schematic presentation of the external right side of the retractable stability fin unit for the extremely large obese user configuration of the invention;

FIG. 5e is the schematic presentation of the entire right side of the retractable stability fin unit for the extremely large obese user configuration of the invention;

FIG. 5f is the schematic presentation of the external left side of the retractable stability fin unit for the extremely large obese user configuration of the invention;

FIG. 5g is the schematic presentation of the entire left side of the retractable stability fin unit for the extremely large obese user configuration of the invention;

FIG. 5h is the schematic presentation of the bottom side of the lower trunk unit with the retractable stability fin units extended for the extremely large obese user configuration of the invention;

FIG. 6a is schematic presentations of left side outer wheel unit of the invention;

FIG. 6b is schematic presentations of right side outer wheel unit of the invention;

FIG. 6c is schematic presentations of steerable drive wheel unit of the invention;

FIG. 6d is schematic presentations of left side inner wheel unit of the invention;

FIG. 6e is schematic presentations of right side inner wheel unit of the invention;

FIG. 6f is schematic presentations of left side movable wheel unit of the invention;

FIG. 6g is schematic presentations of right side movable wheel unit of the invention;

FIG. 7a is schematic presentations of the left side adjustable knee support unit of the invention;

FIG. 7b is schematic presentations of the right side adjustable knee support unit of the invention;

FIG. 8a is schematic presentations of the left side inside view of the lifting arm unit of the invention;

FIG. 8b is schematic presentations of the left side outside view of the lifting arm unit of the invention;

FIG. 8c is schematic presentations of the right side inside view of the lifting arm unit of the invention;

FIG. 8d is schematic presentations of the left side outside view of the lifting arm unit of the invention;

FIG. 9a is schematic presentations of left side extender bar unit of the invention;

FIG. 9b is schematic presentations of the right side extender bar unit of the invention;

FIG. 10 is schematic presentations of the external view of the chin/head holder unit and lift unit of the invention;

FIG. 11 is schematic presentations of the external view of the side mounted winch unit of the invention;

FIG. 12 is schematic presentations of the external view of the front mounted which unit of the invention;

FIG. 13a is an external view of the wireless mode handheld transmitter control unit for the obese user version of the invention;

FIG. 13b is an external view of the wireless mode handheld transmitter control unit for the obese user version of the invention;

FIG. 13c is an external view of the wired mode handheld control unit for the extreme large obese user version of the invention;

FIG. 13c is an external view of the wired mode handheld control unit for the extreme large obese user of the invention;

FIG. 14a is a block diagram of a wireless IR embodiment for the obese user version of the invention;

FIG. 14b is a block diagram of a wireless IR embodiment for the extreme large obese user version of the invention;

FIG. 15a is a block diagram of a wireless RF embodiment for the obese user version of the invention;

FIG. 15b is a block diagram of a wireless RF embodiment for the extreme large obese user version of the invention;

FIG. 16a is a block diagram of a wired embodiment for the obese user version of the invention;

FIG. 16a is a block diagram of a wired embodiment for the extreme large obese user version of the invention;

FIG. 17a is a block diagram of the electronic configuration of the wireless version of the obese version of the invention;

FIG. 17b is a block diagram of the electronic configuration of the wireless version of the extreme large obese version of the invention;

FIG. 18a is a block diagram of the electronic configuration of the wired version of the obese version of the invention;

FIG. 18b is a block diagram of the electronic configuration of the wired version of the extreme large obese version of the invention;

### DETAILED DESCRIPTION OF THE PREFERRED EMBODIMENTS

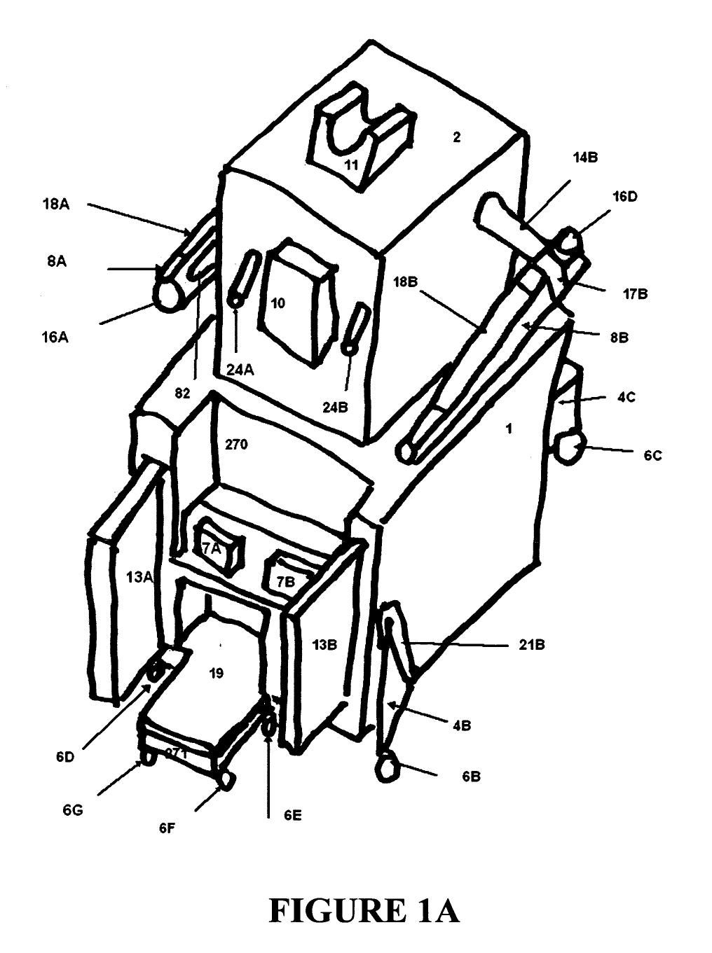

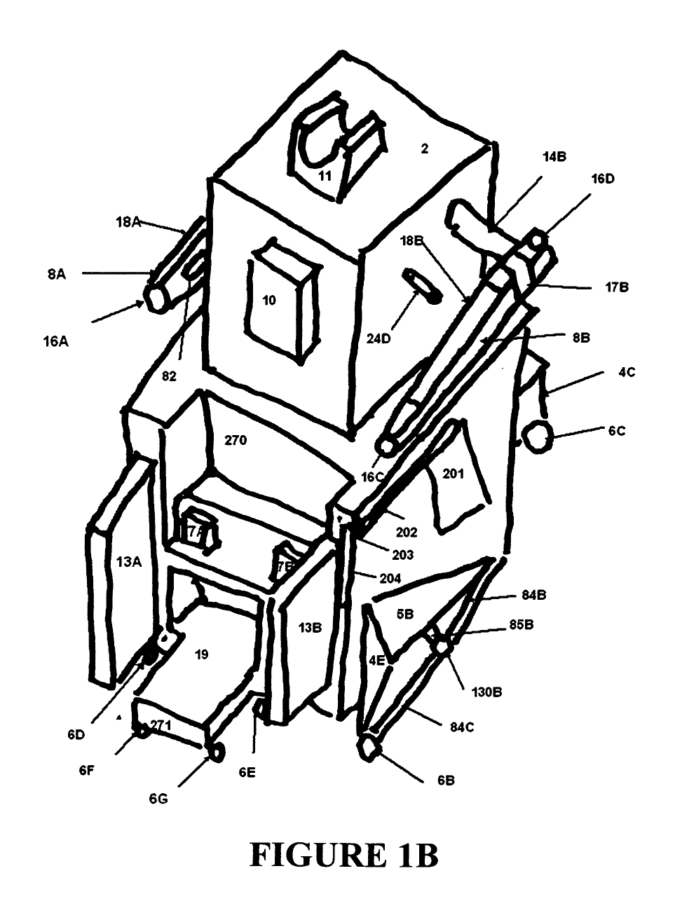

Referring now to the drawings, wherein identical numerals indicate identical parts, and initially in FIGS. 1a and 1b which shows the profile view of the device in its lowest to its elevated position so the user can rise from a seated position and then be located to another position.

FIG. 1a shows the overall external views of the apparatus. FIG. 1a version of the apparatus is for obese users of the apparatus. The obese user apparatus shown in FIG. 1a, consists of a lower trunk unit 1 (within the lower trunk unit 1 is a removable and cleanable cavity liner unit 270), an upper trunk unit 2 that is nested into the lower trunk unit 1 along with the chin/head padded support unit 11 and which is nested into the upper trunk unit 2. Variable geometry stability fin units 4A (not shown), 4B and 4C are attached to the lower trunk unit 1. Variable geometry stability fin units 4A (not shown), 4B and 4C have access through openings 21A (not shown), 21B, and 21C (not shown). The weight, overall height of the user that is to be lifted is programmed into the apparatus's microprocessor unit 140 (not shown), which in turn determine the exact length of these stability fin units 4A (not shown), 4B, and 4C (not shown). The overall height of the invention is also controlled by the microprocessor. The user's physical size and weight dictates what the lifting arm units 8A and 8B length will be and the spread distance between these lift arm units which is determined by the length of extender bar units 14A (not shown) and 14B. Elbow joint sleeve units 17A (not shown) and 17B couples lifting arm units 8A and 8B to extender bar units 14A (not shown) and 14B. On the lower trunk unit 1 is a set of adjustable padded knee support units, 7A and 7B and padded leg constraint panel units 13A and 13B which are adjusted by the operator of the apparatus to fit the user's proportions. The positioning of the upper trunk unit 2, chin/head padded support unit 11, stability fin units 4A (not shown), 4B and 4C, lifting arm units 8A and 8B, padded leg constraint panel units 13A and 13B, fixed front output dispensing cable delivery tubes unit 24A and 24B and extender bar units 14A (not shown) and 14B is by reversible brushless DC motors with appropriate gearheads and various linkage mechanisms (not shown) which are in the control of the operator of the apparatus by means of a handheld control unit 9A (not shown) that has a wireless data link to a transceiver unit 153 (not shown) or 154 (not shown) or a handheld control unit 9B (not shown) has wired data link to converter unit 155 (not shown). The transceiver unit 153 (not shown) or 154 (not shown) is internally connected to the microprocessor unit 140 (not shown) within the apparatus. The apparatus in the obese user version maneuvers by means of wheel units 6A (not shown), 6B, 6D, 6F and 6G and steerable and reversible drive wheel unit 6C. A rigid deflection screen unit 170 (not shown) deflects debris that in the travel path of the apparatus. Debris or small/large depressions in the floor that might effect the stability of the apparatus are detected by the rigid deflection screen unit [170A, 170B and 170C] (not shown) and causes the deflection screen alarm unit 171 (not shown) to be activated and alerts the operator of the apparatus to take evasive action to protect the user of the apparatus. The internal power source unit 131 [not shown] and electronics control unit 132 (not shown) are located in inner portion of lower trunk unit 1 with access through compartment door unit 12A (not shown). If the user is lying on the bed he/she can grasp handle units 16A and 16B. The user stands on footrest platform unit 19 and supported by retractable support platform unit 271. When the user is standing the support platform unit 271 retracts and the user can switch to handle units 16C (not shown) and 16D if desired. Arm pad units 18A and 18B provide cushioning. Also a chest protector pad unit 10 is mounted on the upper trunk unit 2 for the user's comfort and protection. Within lifting arm unit 8A is gear rack unit 82 which allows for movement of lifting arm unit 8A. Similarly, lifting arm unit 8B has gear rack unit 83 (not shown), Fixed front delivery tube units (161A and 161B) [not shown] which are connected to sling/harness unit 220 [not shown]. Throne shaped cavity is able to accommodate the access body mass for both apple and pear shaped obese user of the apparatus.

FIG. 1b shows the overall external views of the apparatus and is used by extremely large obese users whose girth is limited. The apparatus shown in FIG. 1b, consists of a lower trunk unit 1 (within the lower trunk unit 1 is a removable and cleanable throne shaped cavity liner unit 270), an upper trunk unit 2 that is nested into the lower trunk unit 1 along with the chin/head padded support unit 11 and which is nested into the upper trunk unit 2. The user stands on footrest platform unit 19, with retractable support platform unit 271. For the extremely obese user configuration (FIG. 1b), retractable outrigger stability fin units 4D (not shown), 4E and 4C are attached to the lower trunk unit 1. A throne shaped cavity is able to accommodate the access body mass for either the apple or pear shaped extreme large obese user of the apparatus. The weight, overall height of the patient that is to be lifted is programmed into the apparatus's microprocessor unit 140 (not shown). The overall height of the invention is also controlled by the microprocessor. The user's physical height and weight dictates what the lifting arm units 8A and 8B length will be and the spread distance between these lift arm units which is determined by the length of extender bar units 14A (not shown) and 14B. Elbow joint sleeve units 17A (not shown) and 17B couples lifting arm units 8A and 8B to extender bar units 14A (not shown) and 14B. On the lower trunk unit 1 is a set of adjustable padded knee support units, 7A and 7B and padded leg constraint panel units 13A and 13B which are adjusted by the operator of the apparatus to fit the user's proportions. The positioning of the upper trunk unit 2, chin/head padded support unit 11, stability fin units 4A (not shown), 4B and 4C, lifting arm units 8A and 8B, padded leg constraint panel units 13A and 13B, adjustable side output dispensing cable delivery tube units 24C (not shown) and 24D and extender bar units 14A (not shown) and 14B is by reversible brushless DC motors with appropriate gearheads and various linkage mechanisms (not shown) which are in the control of the operator of the apparatus by means of a handheld control unit 9A (not shown) that has a wireless data link to a transceiver unit 153 (not shown) or 154 (not shown) or a handheld control unit 9B (not shown) has wired data link to converter unit 155 (not shown). The transceiver unit 153 or 154 (not shown) is internally connected to the microprocessor unit 140 (not shown) within the device. The apparatus in the extremely large obese version maneuvers by means of wheel units 6A (not shown), 6B, 6D, 6E, 6F, and 6G and steerable and reversible drive wheel unit 6C. A rigid deflection screen units [170C, 170D and 170E] (not shown) deflects debris that in the travel path of the apparatus. Debris or small/large depressions in the floor that might effect the stability of the apparatus are detected by deflection screen unit [170C, 170D and 170E] (not shown) and causes the deflection screen alarm unit 171 (not shown) to be activated and alerts the operator of the apparatus to take evasive action to protect the user of the apparatus. The internal power source unit 131 (not shown) and electronics control unit 132 (not shown) are located in inner portion of lower trunk unit 1 with access through compartment door units 12B and 12C. If the user is lying on the bed he/she can grasp handle units 16A and 16B. The user places his/her feet into a footrest compartment unit 137. A retractable support platform unit 271 extends outward when the user is being lifted/lowered by the apparatus. When the user is in the fully upright position the retractable support platform unit 271 retracts, once standing the user can switch to handle units 16C (not shown) and 16D if desired. Arm pad units 18A and 18B provide cushioning. Also a chest protector pad unit 10 is mounted on the upper trunk unit 2 for the user's comfort. Within lifting arm unit 8A is gear rack unit 82 which allows for movement of lifting arm unit 8A. Similarly, lifting arm unit 8B has gear rack unit 83 (not shown), Retractable fin unit 4E shows the pivotal length leg units 84C and 84D attached to retractable fin unit 4E along with expanding horizontal drive unit 85B and pivotal joint unit 130B. Adjustable side dispensing cable delivery tube units 24C and 24D provide winch cables 161A and 161B (not shown), which then are connected to sling/harness unit 220 (not shown). Sling seat unit 201 provides necessary support to the user that has little or no ability to provide necessary self induced lifting ability. Sling seat unit 201 is connected to pivotal arm unit 202 which in turn is connected to connector arm unit 203. This is then connected to screw nut unit 204 that is then rotated by drive motor unit 206 (not shown) which in turn is connected to screw unit 205 (not shown). The position of screw nut unit 204 determines the height of sling seat unit.

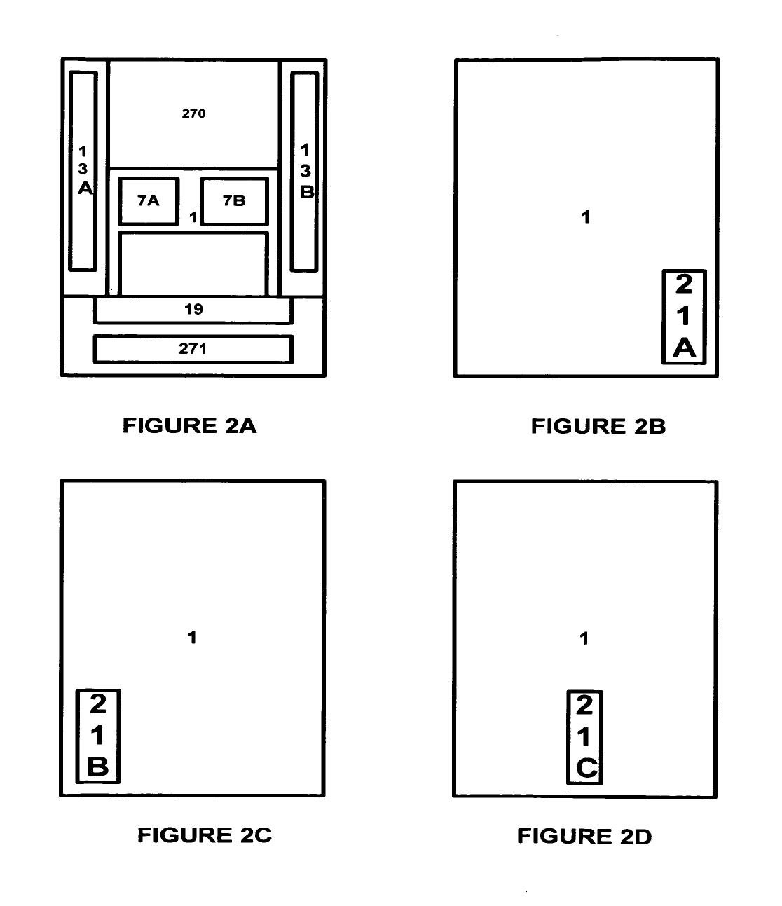

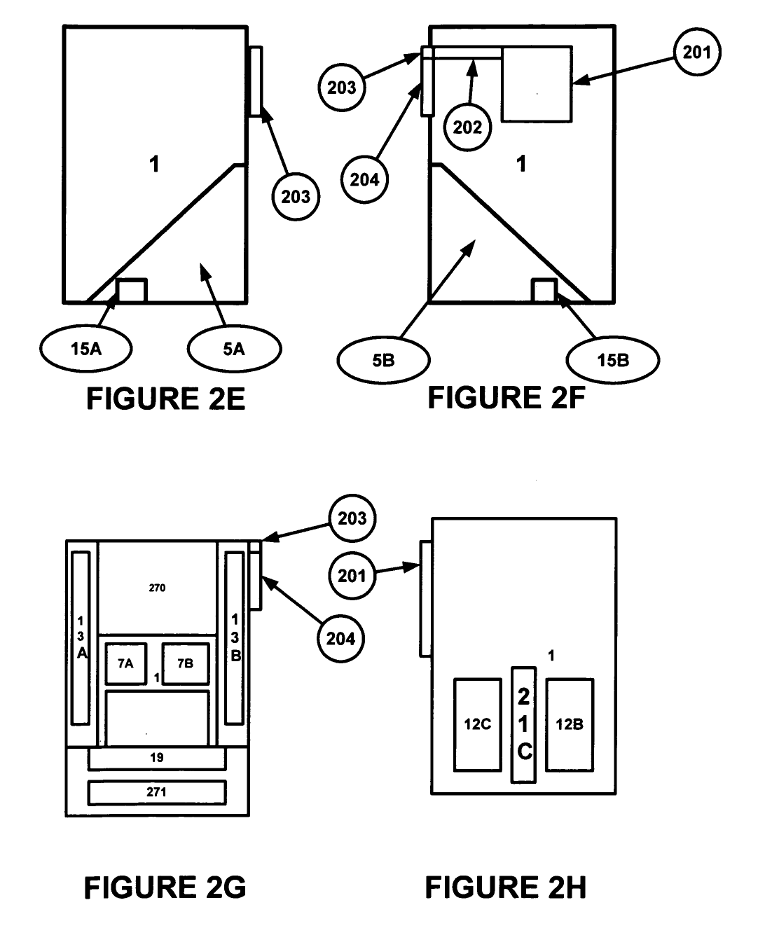

Referring to FIG. 2a which shows the front external view of the lower trunk unit 1 for the obese user configuration. The front external view of the lower trunk unit 1 shows the footrest platform unit 19 retractable support platform unit 271, power source unit 131 (not shown), removable and cleanable cavity liner unit 270 and electronics unit 132 (not shown) of the invention and padded leg constraint panel units 13A and 13B. Adjustable padded knee support units 7A and 7B are shown on the front view.

Referring to FIG. 2b which shows the left external view of the lower trunk unit 1 for the obese user configuration. The left side view shows opening 21A for the variable geometry stability fin unit 4A (not shown).

Referring to FIG. 2c which shows the right external view of the lower trunk unit 1 for the obese user configuration. The right side view shows opening 21B for the variable geometry stability fin unit 4B (not shown).

Referring to FIG. 2d which shows the rear external view of the lower trunk unit 1 for the obese user configuration. The rear external view of the lower trunk unit 1 shows the drive wheel opening 21C for the variable geometry stability fin unit 4C (not shown).

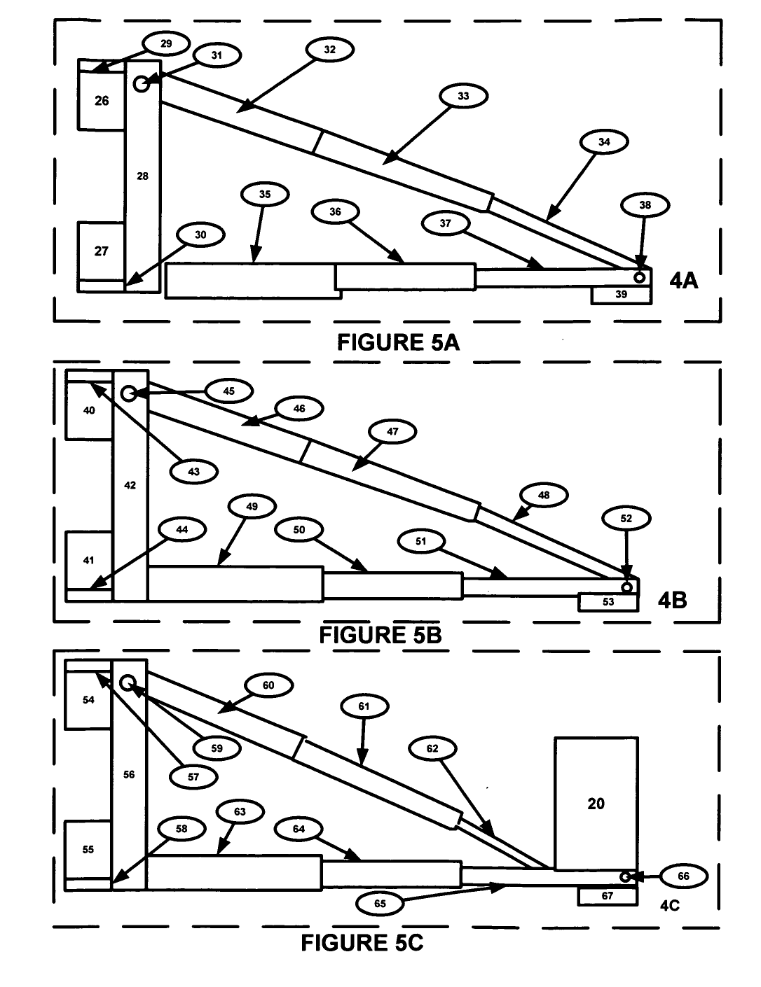

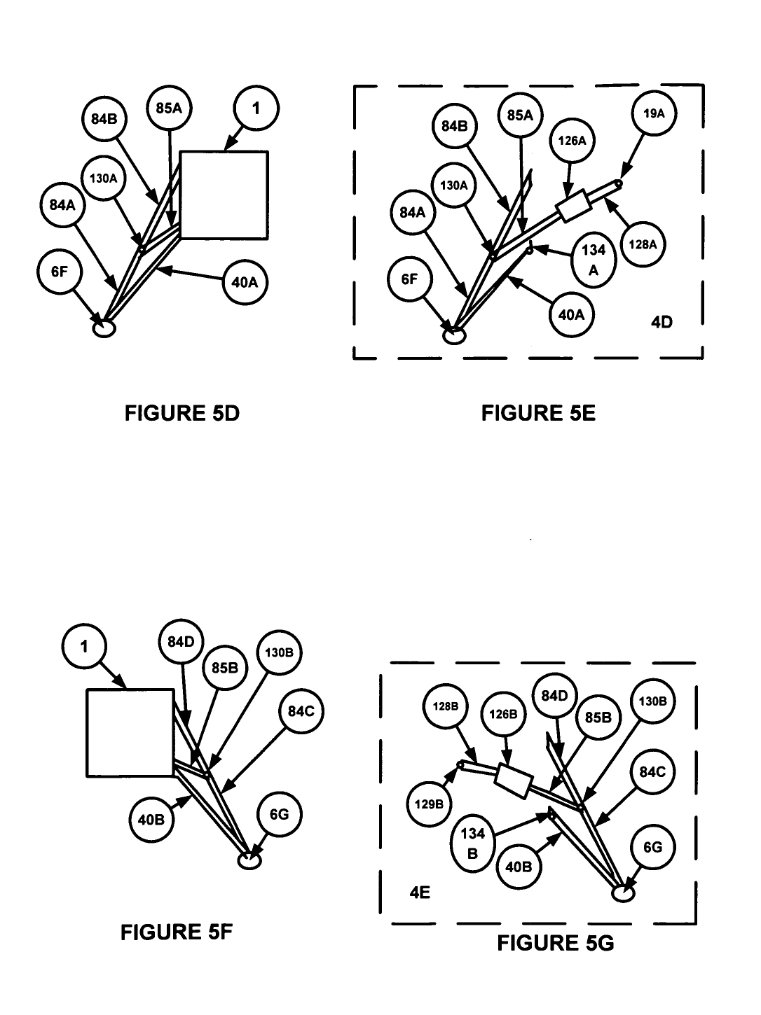

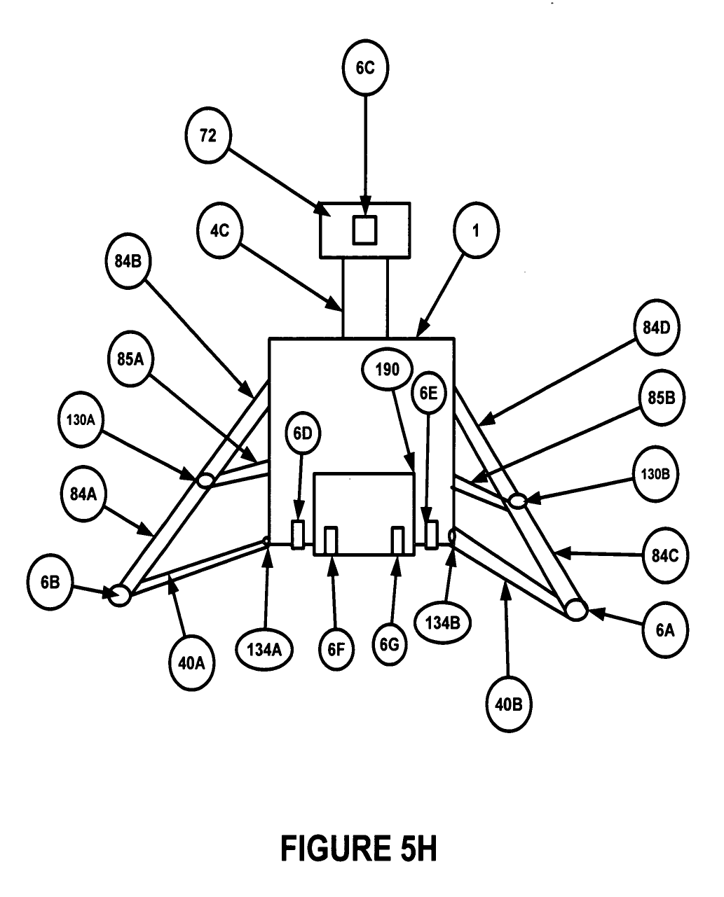

Referring to FIG. 2e which shows the left side external view of the lower trunk unit 1 for the extremely large obese user configuration. The left side view shows opening 5A well, similar to a landing gear wheel well (shown in FIG. 5E) for the retractable outrigger stability fin unit 4D (not shown) and opening 15A for the expanding horizontal drive unit 85A (not shown).

Referring to FIG. 2f, which shows the right side external view of the lower trunk unit 1 for the extremely large obese user configuration. The right side view shows opening 5B well, similar to a landing gear wheel well (shown in FIG. 5G) for the retractable outrigger stability fin unit 4E (not shown) and opening 15B for the expanding horizontal drive unit 85B (not shown) for the retractable outrigger stability fin unit 4E well, similar to a landing gear wheel well. A sling seat unit 201 provides necessary support to the user that has little or no ability to provide necessary self induced lifting ability. Sling seat unit 201 is connected to pivotal arm unit 202 which in turn is connected to connector arm unit 203. This is then connected to screw nut unit 204 that is then rotated by drive motor unit 206 (not shown) which in turn is connected to screw unit 205 (not shown). The position of screw nut unit 204 determines the height of sling seat unit.

Referring to FIG. 2g which shows the front external view of the lower trunk unit 1 for the extremely large obese user configuration. The front external view of the lower trunk unit 1 shows removable and cleanable cavity liner unit 270, footrest platform unit 19 and retractable support platform unit 271 along with wheel units 6D and 6E, which allows for greater stability during raising/lowering the user from seated to risen position of the invention and the padded leg constraint panel units 13A and 13B. Adjustable padded knee support units 7A and 7B are shown on the front view.

Referring to FIG. 2h which shows the rear external view of the lower trunk unit 1 for the extremely large obese user configuration. The rear external view of the lower trunk unit 1 shows the access door units 12A and 12B, along with drive wheel opening 21C.

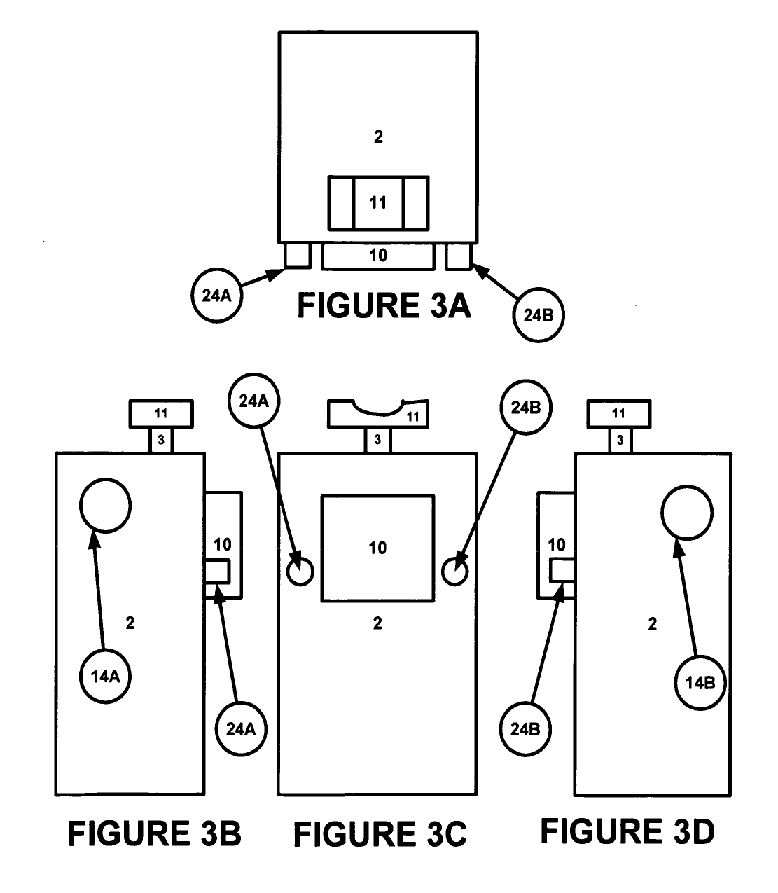

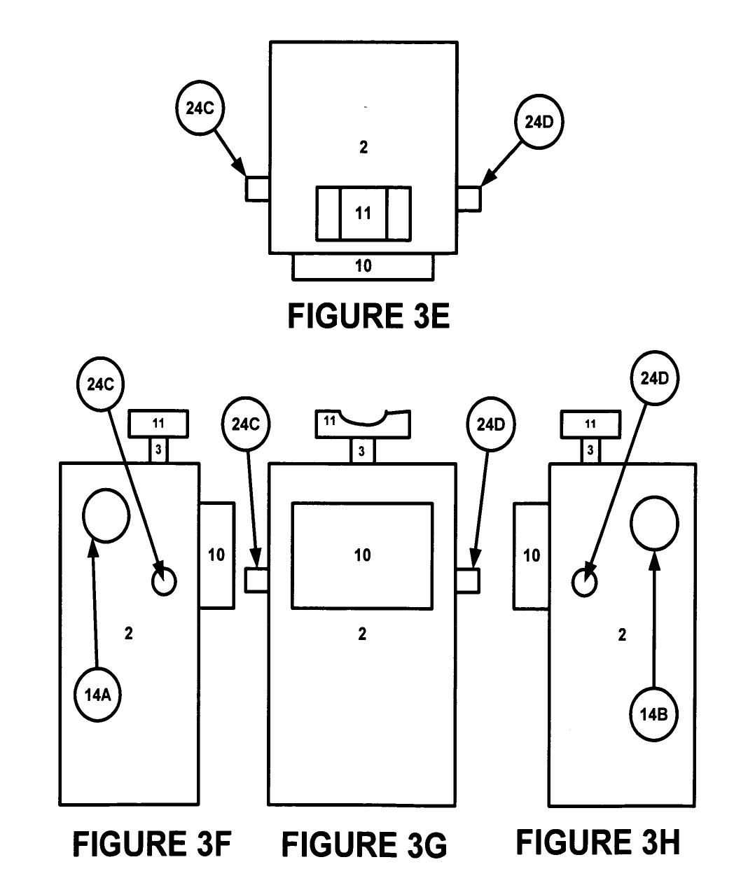

FIG. 3a shows the top external view of the upper trunk unit 2 for the obese user configuration. The top external view of the upper trunk unit 2 shows the chest protector pad unit 10, chin/head padded support unit 11 and fixed front output dispensing delivery tube units 24B and 24C.

FIG. 3b shows the left side external view of the upper trunk unit 2 for the obese user configuration. The left side view shows fixed front output dispensing cable delivery tube unit 24A, extender bar unit 14A along with the chest protector pad unit 10. Chin/head padded support unit 11 and chin/head lift unit 3 can be removed and the remaining depression in upper trunk unit 2 can be covered by a cover plate unit 162 (not shown).

FIG. 3c shows the front external view of the upper trunk unit 2 for the obese user configuration. The front external view of the upper trunk unit 2 shows the chest protector pad unit 10, chin/head padded support unit 11, chin/head lift unit 3 and fixed front output dispensing delivery tube units 24A and 24B. Chin/head padded support unit 11 and chin/head lift unit 3 can be removed and the remaining depression in upper trunk unit 2 can be covered by a cover plate unit 162 (not shown).

FIG. 3d shows the right side external view of the upper trunk unit 2 for the obese user configuration. The left side view shows fixed front output dispensing cable delivery tube unit 24B, extender bar unit 14B along with the chest protector pad unit 10. Chin/head padded support unit 11 and chin/head lift unit 3 can be removed and the remaining depression in upper trunk unit 2 can be covered by a cover plate unit 162 (not shown).

FIG. 3e shows the top external view of the upper trunk unit 2 for the extremely large obese user configuration. The top external view of the upper trunk unit 2 shows the chest protector pad unit 10, chin/head padded support unit 11 and variable side output dispensing delivery tube units 24C and 24D.

FIG. 3f shows the left external view of the upper trunk unit 2 for the extremely large obese user configuration. The left side view shows variable side output dispensing cable delivery tube unit 24C, extender bar unit 14A along with the chest protector pad unit 10. Chin/head padded support unit 11 and chin/head lift unit 3 can be removed and the remaining depression in upper trunk unit 2 can be covered by a cover plate unit 162 (not shown).

FIG. 3g shows the front external view of the upper trunk unit 2 for the extremely large obese user configuration. The front external view of the upper trunk unit 2 shows the chest protector pad unit 10, chin/head padded support unit 11, chin/head lift unit 3 and variable side output dispensing delivery tube units 24C and 24D. Chin/head padded support unit 11 and chin/head lift unit 3 can be removed and the remaining depression in upper trunk unit 2 can be covered by a cover plate unit 162 (not shown).

FIG. 3h shows the left external view of the upper trunk unit 2 for the extremely large obese user configuration. The left side view shows variable side output dispensing delivery tube unit 24D, chin/head padded support unit 11, chin/head lift unit 3 along with the chest protector pad unit 10. The left side view shows extender bar unit 14B. Chin/head padded support unit 11 and chin/head lift unit 3 can be removed and the remaining depression in upper trunk unit 2 can be covered by a cover plate unit 162 (not shown).

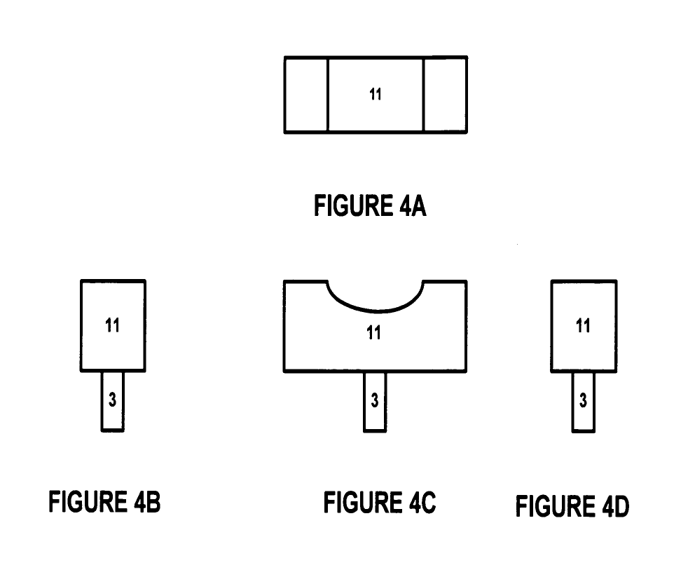

In FIG. 4a which shows the top external view of the chin/head padded support unit 11.

In FIG. 4b which shows the left side external view of the chin/head lift unit 3 shows and chin/head padded support unit 11.

In FIG. 4c which shows the front side external view of the chin/head lift unit 3 shows and chin/head padded support unit 11.

In FIG. 4d which shows the right side external views of the chin/head lift unit 3 shows and chin/head padded support unit 11.

FIG. 5a is the left side external view of the variable geometry stability fin unit for the obese user configuration. The left side view of stability fin unit shows the fixed vertical length leg unit 28 along with expanding horizontal leg units 35, 36 and 37 and expanding diagonal leg units 32, 33 and 34 which in FIG. 5a is denoted as unit 4A. Reversible DC motor with gearhead unit 26 with coupling gears, screw nuts and threaded rod assembly (not shown) which allows reversible DC motor with gearhead unit 27 with coupling gears, screw nuts and threaded rod assembly (not shown) for stability unit 4A fin to expand or contract at a predetermined rate as dictated by the apparatus's microprocessor. Included is connection unit 39, which holds wheel unit 6A. Connection plate unit 29 is used to secure stability fin unit 4A to the roof of lower trunk unit 1 and connection plate unit 30 is used to secure stability fin unit 4A to the floor of the lower trunk unit 1. Connector pin unit 31 allows for the rotation of expanding diagonal leg unit 32 along with connector pin unit 38.

FIG. 5b is the right side external view of the variable geometry stability fin unit for the obese user configuration. The right side view stability unit fin has a fixed length leg unit 42 along with expanding horizontal leg units 49, 50 and 51, and expanding diagonal leg units 46, 47 and 48 which in FIG. 5b is denoted as unit 4B. Reversible DC motor with gearhead unit 40 with coupling gears, screw nuts and threaded rod assembly (not shown) and reversible DC motor with gearhead unit 41 with coupling gears, screw nuts and threaded rod assembly (not shown) which allows unit 4B to expand or contract at a predetermined rate as dictated by the apparatus's microprocessor. Included is connection unit 53, which holds wheel unit 6B. Connection plate unit 43 is used to secure stability fin unit 4B to the roof of lower trunk unit 1 and connection plate unit 44 is used to secure stability fin unit 4B to the floor of the lower trunk unit 1. Connector pin unit 45 allows for the rotation of expanding diagonal leg unit 46 along with connector pin unit 52.

FIG. 5c is the rear external view of the variable geometry stability fin units for the obese user configuration. The rear view of stability fin unit shows stability unit fin which has a fixed length leg unit 56 along with expanding horizontal leg units 63, 64 and 65 which in FIG. 5C is denoted as unit 4C and expanding diagonal leg units 60, 61 and 62 which in FIG. 5c is denoted as unit 4C. Reversible DC motor with gearhead unit 54 with coupling gears, screw nuts and threaded rod assembly (not shown) and reversible DC motor with gearhead unit 55 with coupling gears, screw nuts and threaded rod assembly (not shown) which allows unit 4C to expand or contract at a predetermined rate as dictated by the apparatus's microprocessor. Included is connection unit 67, which holds wheel unit 6C. Connection plate unit 57 is used to secure stability fin unit 4C to the roof of lower trunk unit 1 and connection plate unit 58 is used to secure stability fin 4C to the floor of the lower trunk unit 1. Connector pin unit 59 allows for the rotation of expanding diagonal leg unit 60 along with connector pin unit 66. Attached to stability fin unit 4C is drive/steering mechanism unit 20.

FIG. 5d is the external view of the left side retractable stability fin unit for the extremely large obese user configuration. The left side view of the fin unit 40A shows the pivotal length leg units 84A and 84B along with expanding horizontal drive unit 85A, wheel unit 6F and pivotal joint unit 130A which is attached to lower trunk unit 1.

FIG. 5e is the overall view of the left side retractable stability fin unit and is denoted as 4D for the right side for the extremely large obese user configuration. The side view of the retractable 4D fin unit shows the pivotal length leg units 84A and 84B attached to retractable fin unit 40A with hinge unit 134A along with expanding horizontal drive unit 85A, wheel unit 6F and pivotal joint unit 130A which is denoted as unit 4A. Reversible DC motor with gearhead unit 126A with coupling gears, screw nuts and threaded rod assembly (not shown) which allows reversible DC motor with gearhead unit 126A with coupling gears, screw nuts and threaded rod assembly for retractable stability fin unit 4D to expand or contract at a predetermined rate as dictated by the apparatus's microprocessor. Included is connection unit 129A to attach assembly 128A to the lower trunk unit 1.

FIG. 5f is the external view of the right side retractable stability fin unit for the extremely large obese user configuration. The right side view of the fin unit 40B fin unit shows the pivotal length leg units 84C and 84D along with expanding horizontal drive unit 85B, wheel unit 6G and pivotal joint unit 130B which is attached to lower trunk unit 1.

FIG. 5g is the overall view of the retractable stability fin unit denoted as 4E for the right side for the extremely large obese user configuration. The side view of the retractable 4E fin unit shows the pivotal length leg units 84C and 84D attached to retractable fin unit 40B with hinge unit 134B along with expanding horizontal drive unit 85B, wheel unit 6G and pivotal joint unit 130B which is denoted as unit 4E. Reversible DC motor with gearhead unit 126B with coupling gears, screw nuts and threaded rod assembly (not shown) which allows reversible DC motor with gearhead unit 126B with coupling gears, screw nuts and threaded rod assembly for retractable stability fin unit 4E to expand or contract at a predetermined rate as dictated by the apparatus's microprocessor. Included is connection unit 129B to attach assembly 128A to the lower trunk unit 1.

FIG. 5h is the external, bottom view of the lower trunk unit 1 with the retractable stability fin units 4D and 4E fully extended for the extremely large obese user configuration. Retractable stability fin unit 4D shows the pivotal length leg units 84A and 84B attached to retractable fin unit 40A with hinge unit 134A along with expanding horizontal drive unit 85A and pivotal joint unit 130A. While retractable fin unit 4E shows the pivotal length leg units 84C and 84D with hinge unit 134B along with expanding horizontal drive unit 85B and pivotal joint unit 130B. Stability fin unit 4C is drive/steering mechanism for the apparatus and wheel unit 6C is attached to the end of stability fin unit 4C with wheel housing unit 72. Also there are wheel units 6D, 6E, 6F and 6G to provide additional balance and better weight distribution to the apparatus.

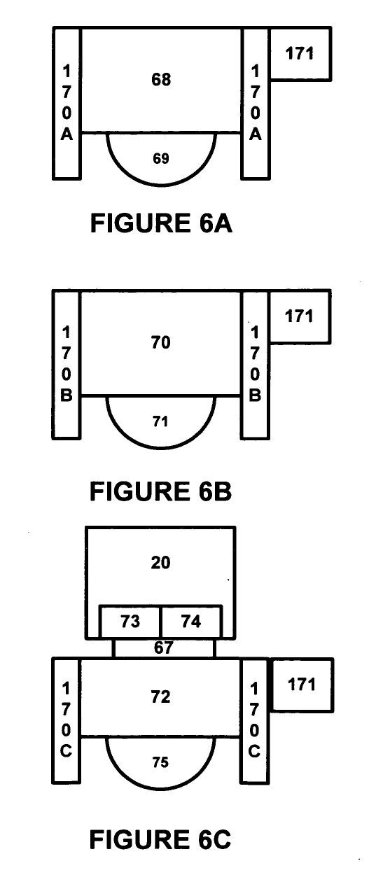

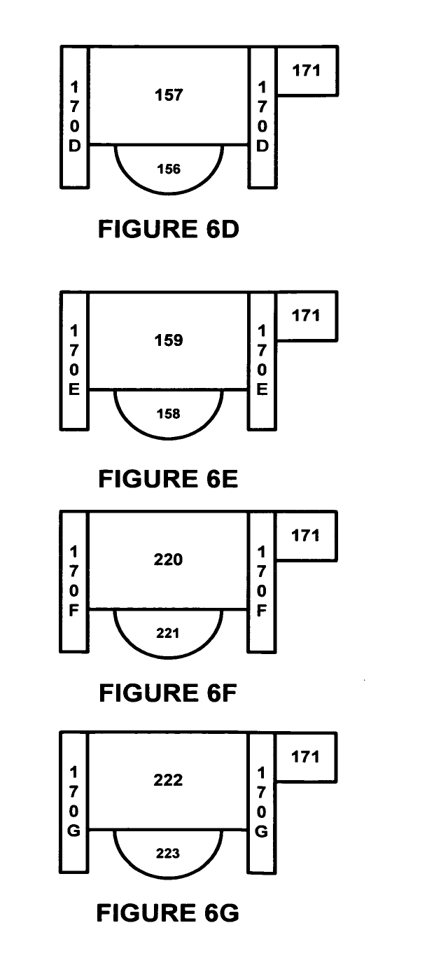

In FIG. 6a is shown the outer left side external side view of wheel unit 6A. Wheel unit 6A consists of wheel 69 and wheel housing unit 68. Wheel housing unit 68 is connected to connection unit 39. Also included are rigid deflection screen unit 170A and deflection screen alarm unit 171

In FIG. 6b is shown the outer right side external side view of wheel unit 6B. Wheel housing unit 68 is connected to connection unit 39. Similarly, wheel unit 6B consists of wheel 71 and wheel housing unit 70. Wheel housing unit 70 is connected to connection unit 53. Also included are rigid deflection screen unit 170B and deflection screen alarm unit 171.

In FIG. 6c is shown the rear external side view of drive wheel unit 6C. Drive wheel unit 6C consist of drive wheel 75 and wheel housing unit 72. Wheel housing unit 72 is connected to connection unit 67, which in turn is connected to drive/steering mechanism unit 20. Within drive/steering mechanism unit 20 are the drive unit 73 and 74 which consists of a reversible DC motor gearhead linkage assembly (not shown) drive unit (not shown) and steering unit 74, which consists a reversible DC motor gearhead linkage assembly drive unit (not shown). Appropriate control signals from the microprocessor operate these two DC motor units. Also included are rigid deflection screen unit 170C and deflection screen alarm unit 171

In FIG. 6d is shown the inner left side external side view of wheel unit 6D. Wheel unit 6D consists of wheel 156 and wheel housing unit 157. Wheel housing unit 157 is connected to connection unit 160 (not shown). Also included are rigid deflection screen unit 170D and deflection screen alarm unit 171

In FIG. 6e is shown the inner right side external side view of wheel unit 6E. Wheel housing unit 159 is connected to connection unit 161. Similarly, wheel unit 6E consists of wheel 158 and wheel housing unit 159. Wheel housing unit 159 is connected to connection unit 161. Also included are rigid deflection screen unit 170E and deflection screen alarm unit 171.

In FIG. 6f is shown the movable left side external side view of wheel unit 6F. Wheel unit 6F consists of wheel 221 and wheel housing unit 220. Wheel housing unit 221 is connected to connection unit 224 (not shown). Also included are rigid deflection screen unit 170F and deflection screen alarm unit 171

In FIG. 6g is shown the movable right side external side view of wheel unit 6G. Wheel housing unit 223 is connected to connection unit 222. Similarly, wheel unit 6G consists of wheel 223 and wheel housing unit 222. Wheel housing unit 222 is connected to connection unit 235 (not shown). Also included are rigid deflection screen unit 170G and deflection screen alarm unit 171.

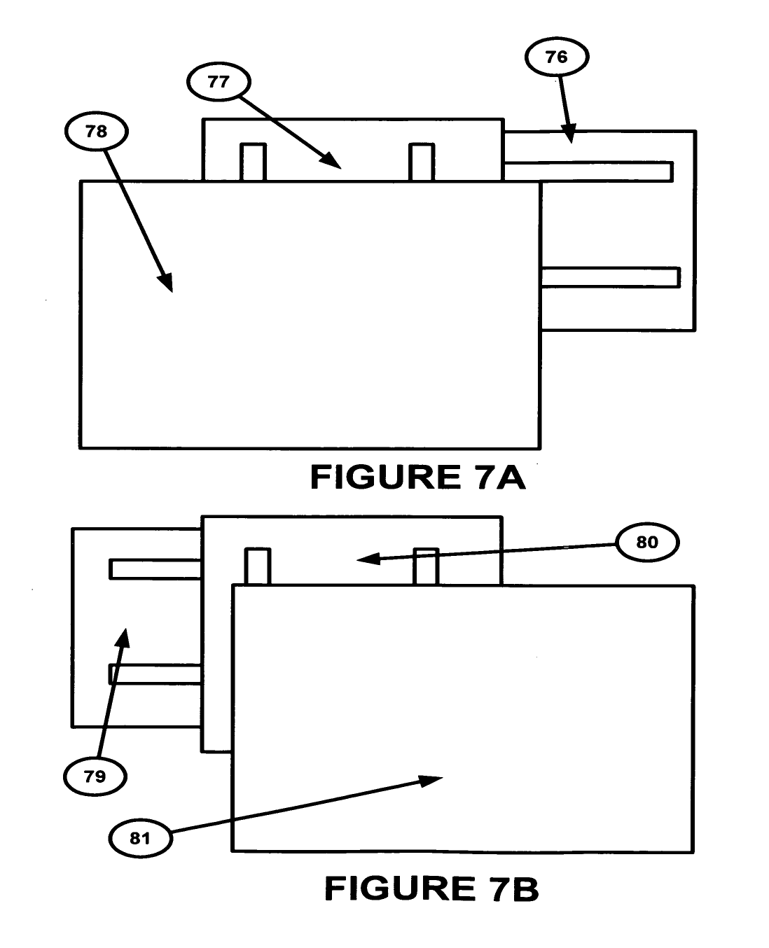

FIG. 7a shows the external front view of left side adjustable knee support unit 7A. Knee support unit 7A consists of the horizontal adjustment plate unit 76, the vertical adjustment plate unit 77 and knee support pad 78. Horizontal adjustment plate unit 76 is attached to lower trunk unit 1 by means of fasteners (not shown), vertical adjustment plate unit 77 is attached to horizontal adjustment plate unit 76 by means of fasteners (not shown) and knee support pad 78 is permanently attached to the vertical adjustment plate unit 77 but is allowed to move in the slots by pins secured by a flange unit on each pin within adjustment plate unit 78 (not shown) and is allowed to move in the slots by pins secured by a flange unit on each pin within vertical plate unit 77 (not shown) as shown in FIG. 7a.

FIG. 7b shows the external right side front view of adjustable knee support unit 7B. Knee support unit 7B consists of the horizontal adjustment plate unit 79, the vertical adjustment plate unit 80 and knee support pad 81. Horizontal adjustment plate unit 79 is attached to lower trunk unit 1 by means of fasteners {not shown}, vertical adjustment plate unit 80 is attached to horizontal adjustment plate unit 79 by means of fasteners (not shown) and knee support pad 81 is permanently attached to the vertical adjustment plate unit 80 but is allowed to move in the slots by pins secured by a flange unit on each pin within adjustment plate unit 80 (not shown) and is allowed to move in the slots by pins secured by a flange unit on each pin within vertical plate unit 80 (not shown) as shown in FIG. 7b.

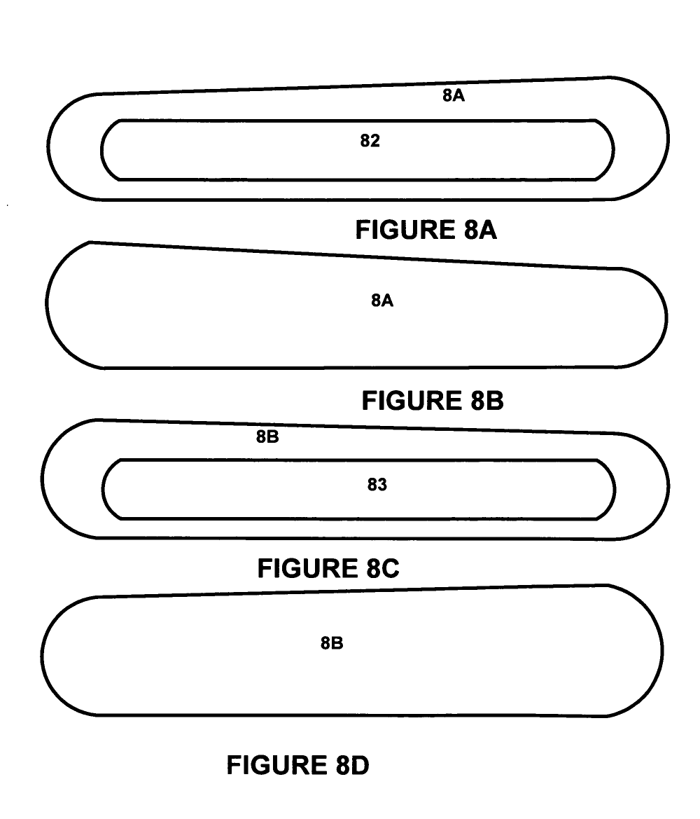

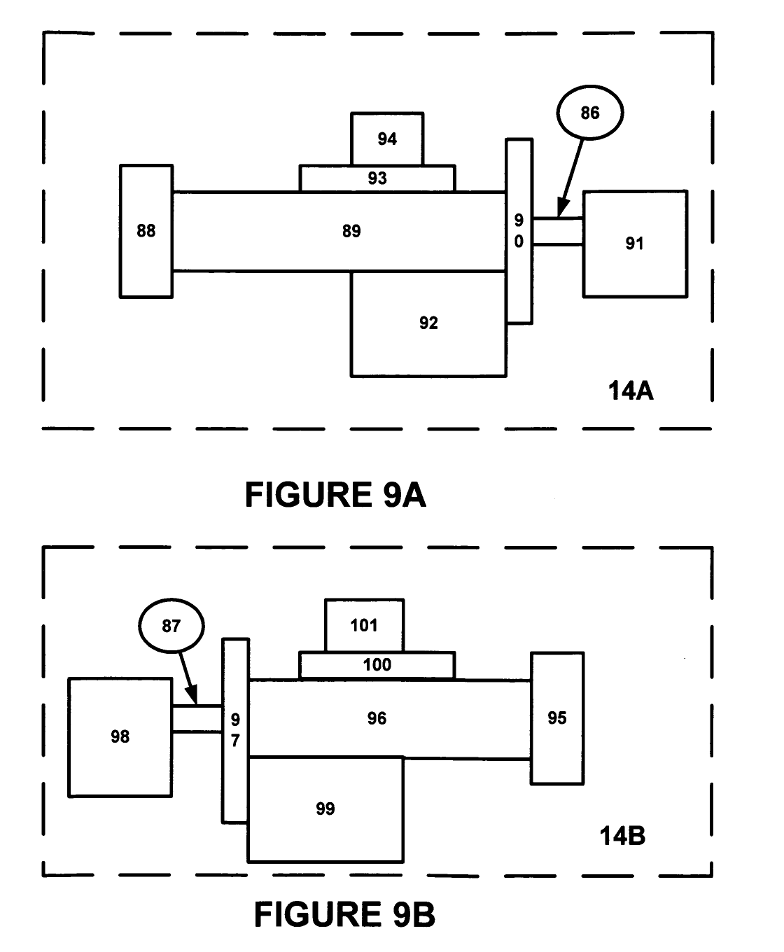

In FIG. 8a is shown the external view of the inside lifting arm unit 8A. The inside view of lifting arm unit 8A shows the overall lifting arm unit 8A and the gear rack unit 82 in which the extender connector rod unit 86 (not shown) from the extender bar unit 14A (not shown) is mated. Drive gear unit 88 (see FIG. 9) engages gear rack unit 82 and moves lifting arm unit 8A to assist the patient to be raised to a standing position and extender connector rod unit 86 {see FIG. 9a} allows the lifting arm unit 8A to move up and down.

In FIG. 8b is shown the external view of the outside lifting arm units 8A.

In FIG. 8c is shown the external view of the inside lifting arm unit 8B. The inside view of lifting arm unit 8B shows the overall lifting arm unit 8B and the gear rack unit 83 in which the extender connector rod unit 87 from the extender bar unit 14B is mated. Drive gear unit 95 (see FIG. 9) engages gear rack unit 83 and moves lifting arm unit 8B to assist the patient to be raised to a standing position and extender connector rod unit 87 (see FIG. 9b) allows the lifting arm unit 8B to move up and down.

In FIG. 8d is shown the external views of the outside lifting arm unit 8B.

FIG. 9a is the side view of extender bar unit 14A shows extender connector rod unit 86 which is connected to reversible DC motor unit 91 which is connected to lifting arm unit 8A (not shown). Drive gear unit 88 is connected to a shaft unit 232 {not shown} which in turn is connected to a reversible DC motor unit 90 that moves extender arm unit 8A (not shown) back and forth. Gear rack unit 93 is connected to sleeve unit 89, which is the outside covering of extender bar unit 14A. It has a rectangular end and is threaded. Reversible DC motor unit 94 engages gear rack unit 93 that allows the extender bar unit 14A to move in and out of upper trunk unit 2. Motor unit 92 rotates lifting arm unit 8A (not shown). Motor units 94 and 92 are fastened to the wall of upper trunk unit 2 to hold extender bar unit 14A in place.

FIG. 9b shows the side view of extender bar unit 14B shows extender connector rod unit 87 which is connected to reversible DC motor unit 98 which is connected to lifting arm unit 8B (not shown). It has a rectangular end and is threaded. Drive gear unit 95 is connected to a shaft (not shown) which in turn is connected to a reversible DC motor unit 97 that moves extender arm unit 8B (not shown) back and forth. Gear rack unit 100 is connected to sleeve unit 96, which is the outside covering of extender bar unit 14B. Reversible DC motor unit 101 engages gear rack unit 100 that allows the extender bar unit 14B to move in and out of middle trunk unit 2. Motor unit 99 rotates lifting arm 8B (not shown). Motor units 99 and 101 are fastened to the wall of upper trunk unit 2 to hold extender bar unit 14B in place.

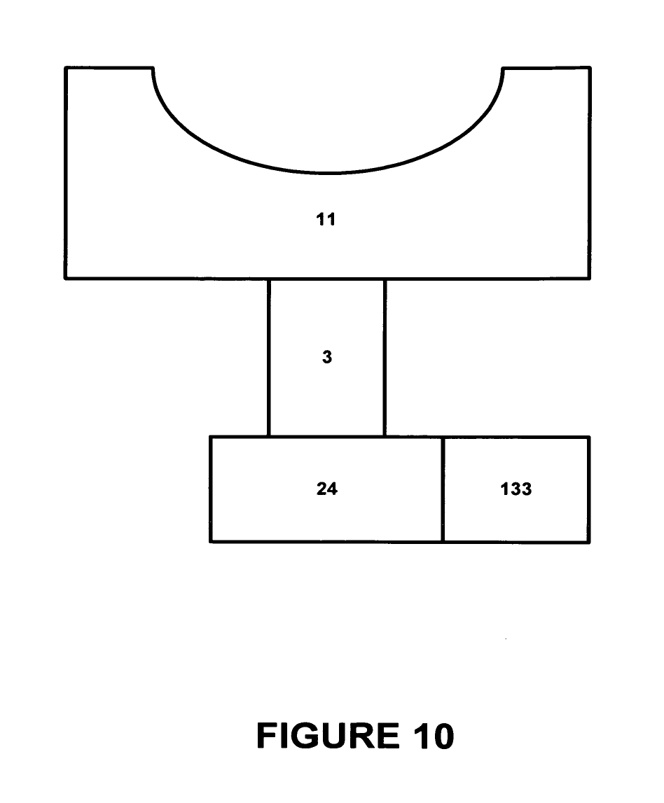

In FIG. 10 is shown external view of the chin/head holder unit 11, chin/head lift unit 3, lift mechanism unit 24 and reversible DC motor unit 133. DC motor unit 133 is coupled to lift mechanism unit 24 which in turns raise/lowers chin/head lift unit 3 and in turn raises/lowers chin/head holder unit 11.

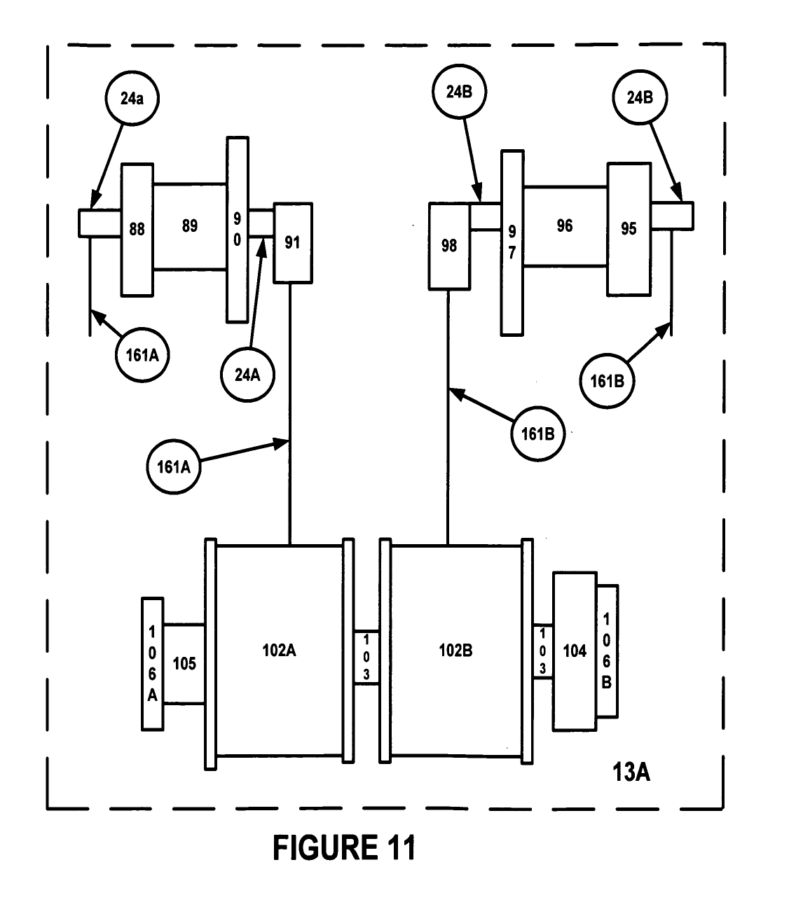

In FIG. 11 shows side mounted sling winch unit configuration for the obsess version of the apparatus and is denoted as 13A. Attachment plate units 106A and 106B and reversible DC motor unit 104, reel units 102A which in turn is connected to shaft unit 105 at one end and drive shaft unit 103 at the other end and reel unit 102B is connected to shaft unit 103. Winch cable 161A is attached to reel unit 102A and winch cable 161B is attached to reel unit 102B. Winch cable 161A is connected to coupler unit 91 which is connected to adjustable side output dispensing cable delivery tube unit 24A shown in FIG. 1a. Drive gear unit 88 is connected to a shaft unit 234 (not shown) within the adjustable side output dispensing cable delivery tube unit 24A which in turn is connected to a reversible DC motor unit 90 that moves adjustable side output dispensing cable delivery tube unit 24A back and forth. Likewise, Winch cable 161B is connected to coupler unit 98 which is connected to adjustable side output dispensing cable delivery tube unit 24B shown in FIG. 1a. Drive gear unit 95 is connected to a shaft {not shown} within the adjustable side output dispensing cable delivery tube unit 24B which in turn is connected to a reversible DC motor unit 97 that moves adjustable side output dispensing cable delivery tube unit 24B back and forth

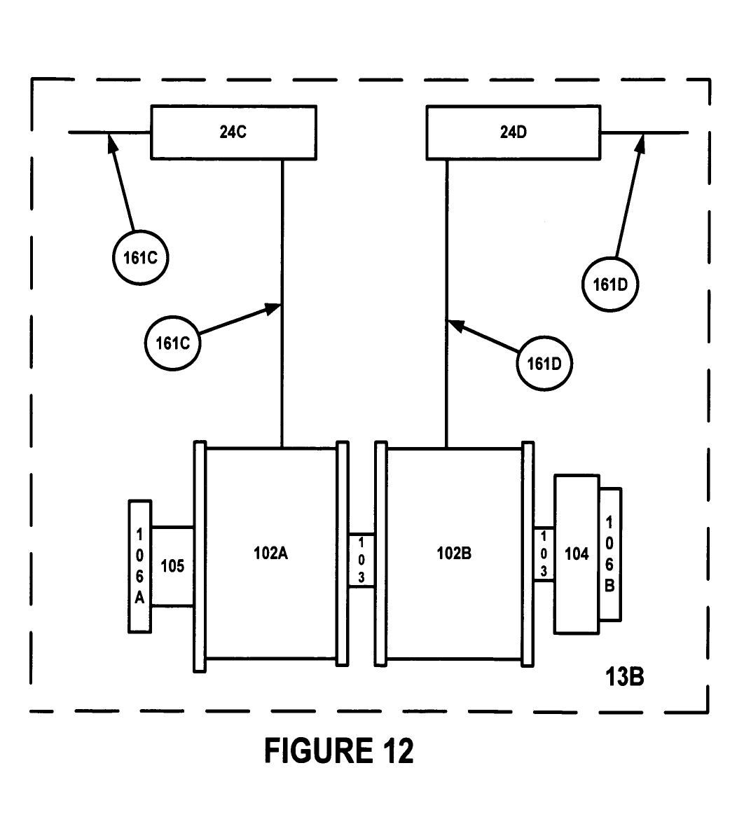

In FIG. 12 shows front mounted sling winch unit configuration of the extreme large obese version of the apparatus as 13A. Attachment plate units 106A and 106B and reversible DC motor unit 104, reel units 102A which in turn is connected to shaft 105 at one end and drive shaft 103 at the other end and reel unit 102B is connected to shaft unit 103. Winch cable 161A is attached to reel unit 102A and winch cable 161B is attached to reel unit 102B. Winch cable 161A is connected to the fixed front mounted output dispensing cable delivery tube unit 24C shown in FIG. 1b. Likewise, Winch cable 161B is connected to a fixed front mounted output dispensing cable delivery tube unit 24D shown in FIG. 1b.

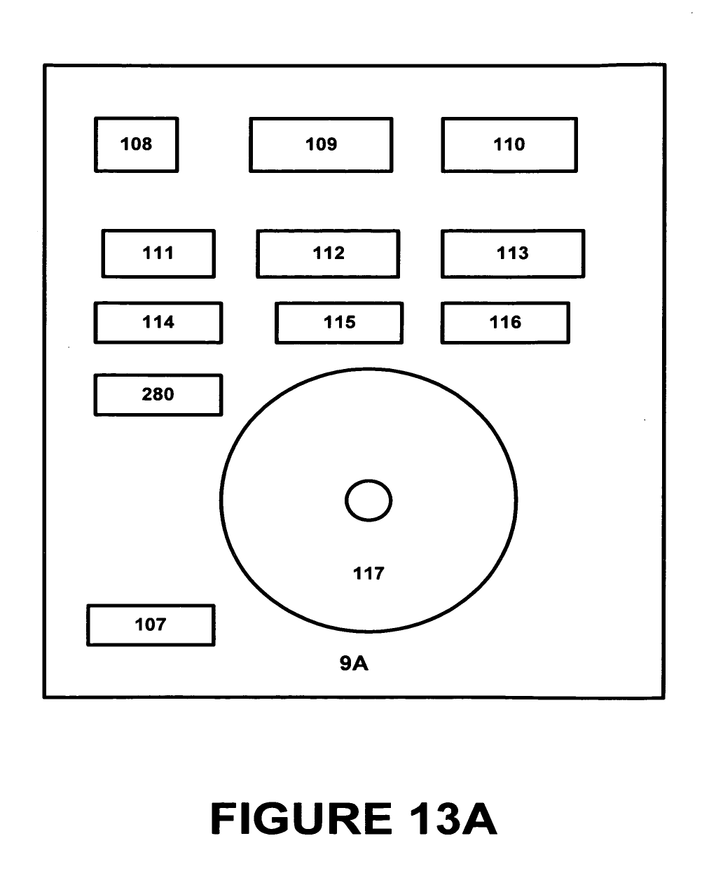

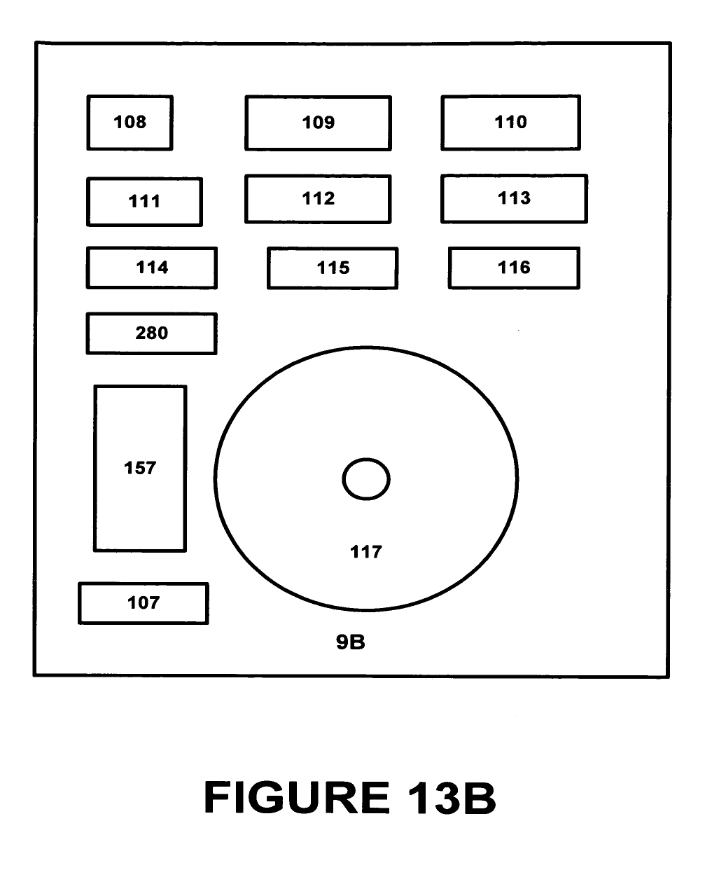

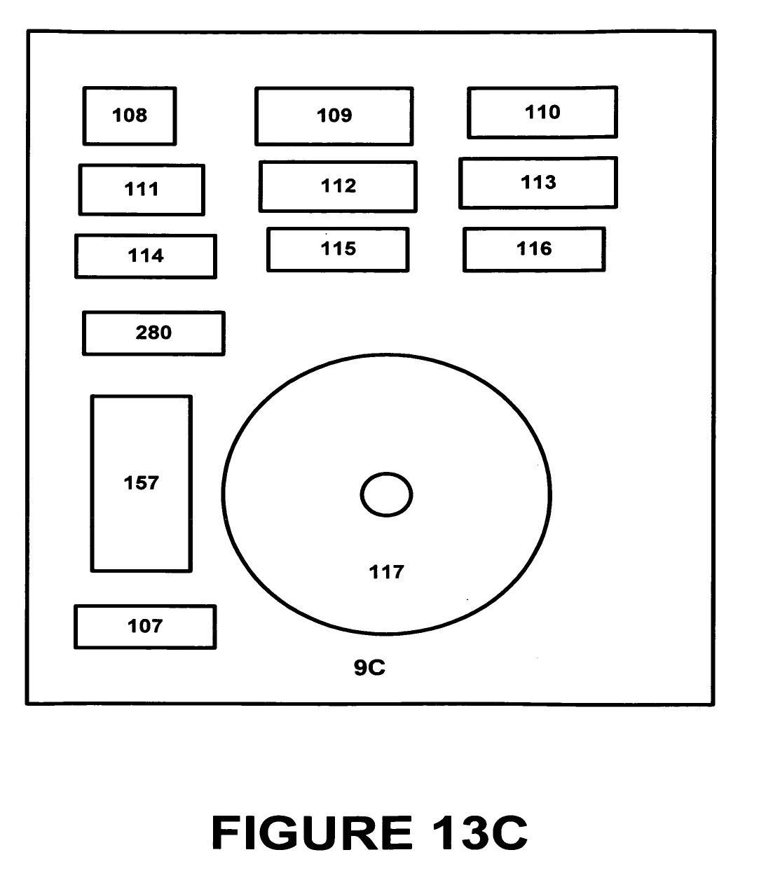

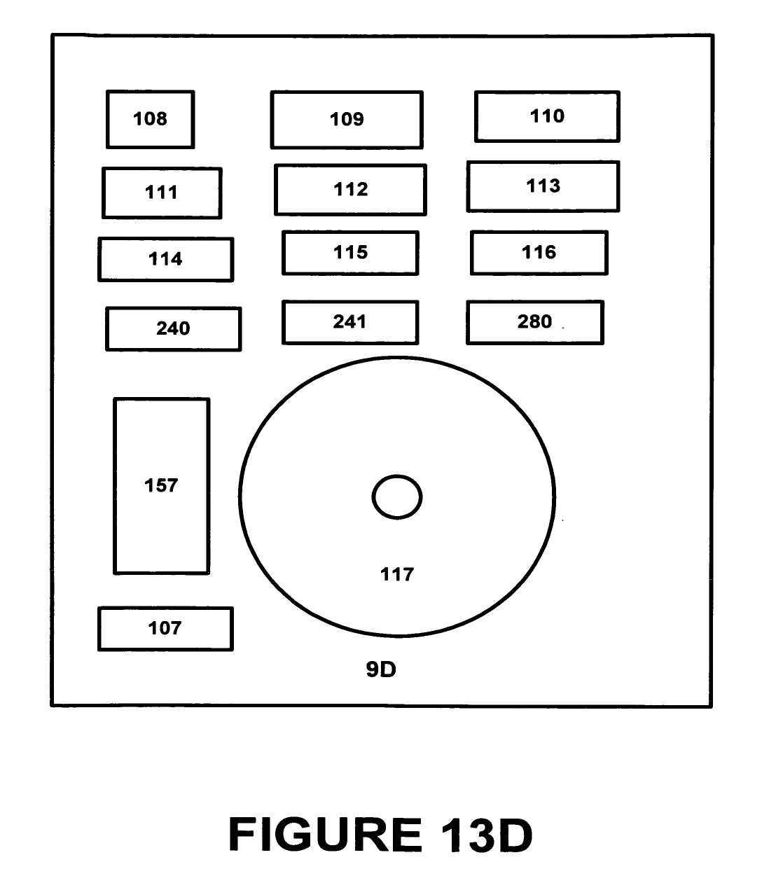

FIG. 13a shows the external view of the wireless handheld control unit 9A for obese version of the apparatus. The apparatus switch unit 107 turns the power on or off to the apparatus, switch unit 108 which extends or retracts the variable stability fin units 4A, 4B and 4C, switch unit 109 raises and lowers the upper trunk unit 2, switch unit 110 raises and lowers chin/head padded support unit 11, switch unit 111 controls the in and out movements of extender bar units 14A and 14B, switch unit 112 controls the in and out movements of lifting arm units 8A and 8B and switch unit 113 rotates the lifting arm units 8A and 8B in the vertical or horizontal plane or somewhere in between. Switch unit 115 turns on the power to the winch unit 13 and switch allows the winch reel unit 114 to reel in or out the cord/wire as required. Switch unit 116 provides power for support platform unit 271 and switch unit 280 controls the power for extending/retracting side panel units 13A and 13B of the apparatus. Joystick unit 117 controls the forward/reverse motion and right and left turns as required set and the speed of the apparatus.

FIG. 13b shows the external view of the wireless handheld control unit 9B for extreme large obese version of the apparatus. The apparatus switch unit 107 turns the power on or off to the apparatus, switch unit 108 which extends or retracts the variable stability fin units A, B and C, switch unit 109 raises and lowers the upper trunk unit 2, switch unit 110 raises and lowers chin/head padded support unit 11, switch unit 111 controls the in and out movements of extender bar units 14A and 14B, switch unit 112 controls the in and out movements of lifting arm units 8A and 8B and switch unit 113 rotates the lifting arm units 8A and 8B in the vertical or horizontal plane or somewhere in between. Switch unit 115 turns on the power to the winch unit 13 and switch allows the winch reel unit 114 to reel in or out the cord/wire as required. Switch unit 116 provides power for support platform unit 271 and switch unit 280 controls the power for extending/retracting side panel units 13A and 13B of the apparatus. Joystick unit 117 controls the forward/reverse motion and right and left turns as required set and the speed of the apparatus. Switch unit 240 is to engage or disengage sling seat unit 201 and switch unit 241 is to raise or lower sling seat unit 201.

FIG. 13c shows the external view of the wired handheld control unit 9C for the obese version of the apparatus. The apparatus switch unit 107 turns the power on or off to the apparatus, switch unit 108 which extends or retracts the variable stability fin units A, B and C, switch 109 raises and lowers the upper trunk unit 2, switch unit 110 raises and lowers chin/head holder unit 11, switch unit 111 controls the in and out movements of extender bar units 14A and 14B, switch unit 112 controls the in and out movements of lifting arm units 8A and 8B and switch unit 113 rotates the lifting arm units 8A and 8B in the vertical or horizontal plane or somewhere in between. Switch unit 115 turns on the power to the winch unit 13 and switch allows the winch reel unit 114 to reel in or out the cord/wire as required. Switch unit 116 provides power for drive motor for support platform unit 271 and switch unit 280 controls the power for extending/retracting side panel units 13A and 13B of the apparatus. Joystick unit 117 controls the forward/reverse motion and right and left turns as required set and the speed of the apparatus. Monitor unit 157 monitors the status of the onboard apparatus power source.

FIG. 13d shows the external view of the wired handheld control unit 9D for the extreme large obese version of the apparatus. The apparatus switch unit 107 turns the power on or off to the apparatus, switch unit 108 which extends or retracts the variable stability fin units A, B and C, switch 109 raises and lowers the upper trunk unit 2, switch unit 110 raises and lowers chin/head holder unit 11, switch unit 111 controls the in and out movements of extender bar units 14A and 14B, switch unit 112 controls the in and out movements of lifting arm units 8A and 8B and switch unit 113 rotates the lifting arm units 8A and 8B in the vertical or horizontal plane or somewhere in between. Switch unit 115 turns on the power to the winch unit 13 and switch allows the winch reel unit 114 to reel in or out the cord/wire as required. Switch unit 116 provides power for drive motor for support platform unit 271 and switch unit 280 controls the power for extending/retracting side panel units 13A and 13B of the apparatus. Joystick unit 117 controls the forward/reverse motion and right and left turns as required set and the speed of the apparatus. Monitor unit 157 monitors the status of the onboard apparatus power source. Switch unit 240 is to engage or disengage sling seat unit 201 and switch unit 241 is to raise or lower sling seat unit 201.

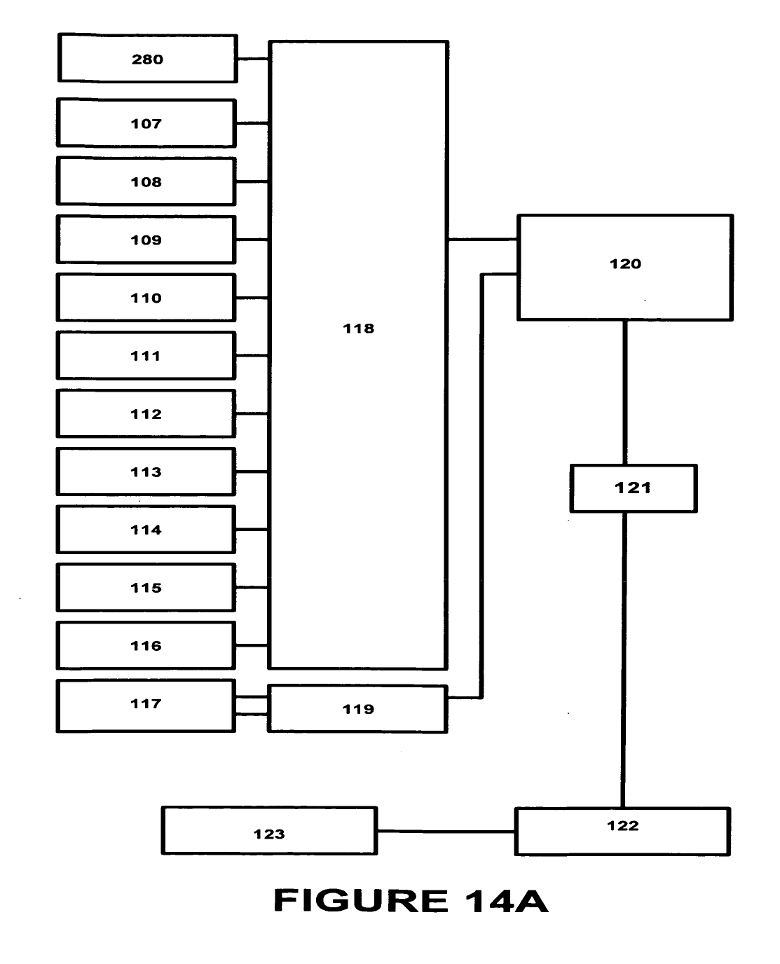

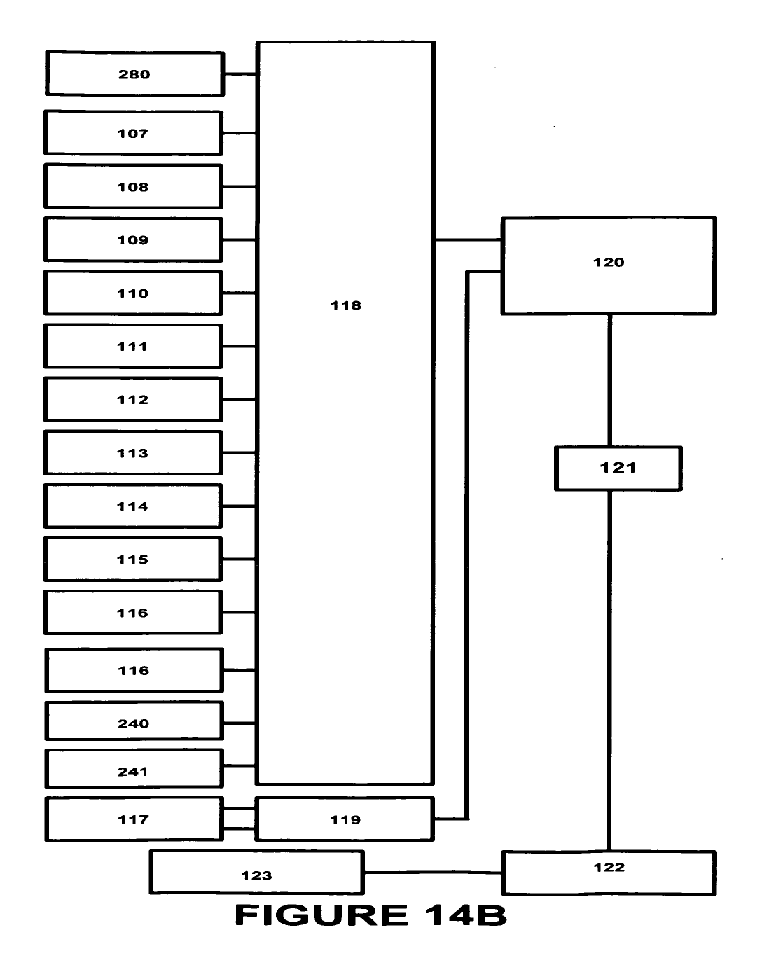

As shown in FIG. 14a for the obese version of the apparatus, an IR transmitter unit comprises of the following components: (1) Switch input units 107 . . . 117 and 280, (2) Encoder unit 118, (3) Joystick input unit 117, (4) 2 Channel A/D Converter unit 119, (5) Combiner unit 120, (6) Filter unit 121, (7) Transmitter processor unit 122, and (8) Transmitter/Light source unit 123. Digital data is sent to the combiner unit 120, the output is transferred to the Transmitter Processor unit 121 and is put into data packets with error correction algorithms, the output activates the transmitter/light source unit 123.

As shown in FIG. 14b for the extreme large obese version of the apparatus, an IR transmitter unit comprises of the following components: (1) Switch input units 107 . . . 117, 240, 241 and 280, (2) Encoder unit 118, (3) Joystick input unit 117, (4) 2 Channel A/D Converter unit 119, (5) Combiner unit 120, (6) Filter unit 121, (7) Transmitter processor unit 122, and (8) Transmitter/Light source unit 123. Digital data is sent to the combiner unit 120, the output is transferred to the Transmitter Processor unit 121 and is put into data packets with error correction algorithms, the output activates the transmitter/light source unit 123.

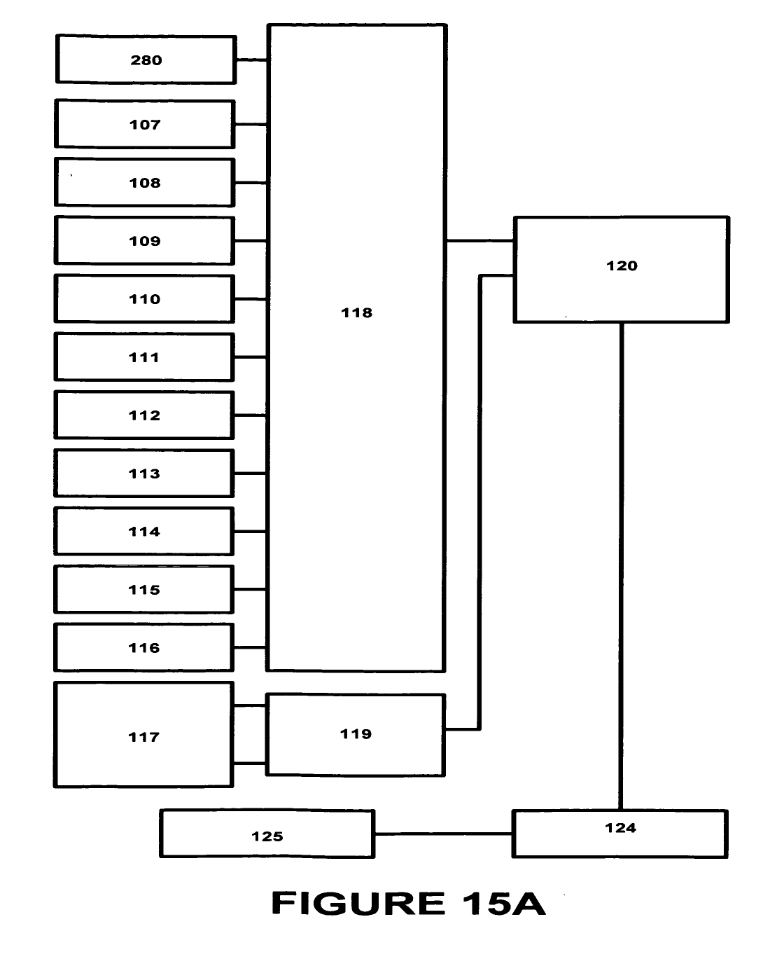

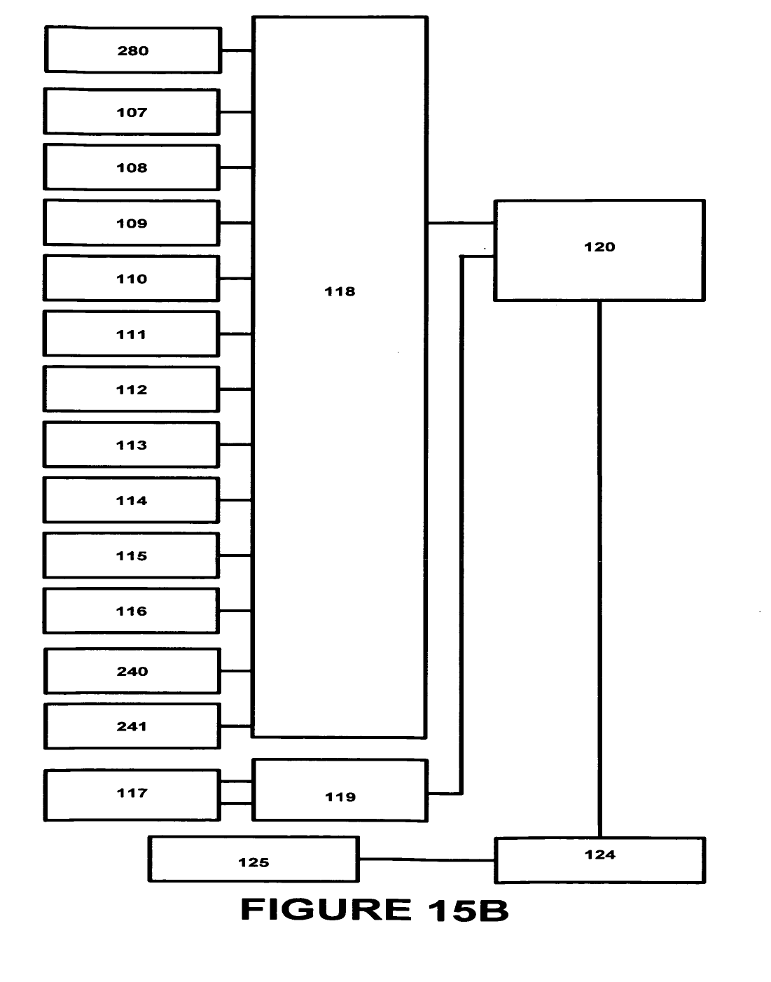

In FIG. 15a for the obese version of the apparatus, a RF transmitter unit comprises of the following components: Switch input units 107 . . . 117 and 280, (2) Encoder unit 118, (3) Joystick input unit 117, (4) 2 Channel A/D Converter unit 119, (5) Combiner unit 120, (6) Filter unit 121, (7) Transmitter unit 125, and (8) Signal processor/modulator unit 124. The transmitter unit 125 provides the modulation of the RF signal waveform. On the transmit side, the transmitter unit 125 accepts outgoing data messages from the signal processor/modulator 125, continuous phase modulates the digital information, up-converts the frequency to RF frequencies, performs frequency hopping, and provides RF power amplification for output to the Transmitter's antenna.

In FIG. 15b for the extreme large obese version of the apparatus, a RF transmitter unit comprises of the following components: Switch input units 107 . . . 117, 240, 241 and 280, (2) Encoder unit 118, (3) Joystick input unit 117, (4) 2 Channel A/D Converter unit 119, (5) Combiner unit 120, (6) Filter unit 121, (7) Transmitter unit 125, and (8) Signal processor/modulator unit 124. The transmitter unit 125 provides the modulation of the RF signal waveform. On the transmit side, the transmitter unit 125 accepts outgoing data messages from the signal processor/modulator 125, continuous phase modulates the digital information, up-converts the frequency to RF frequencies, performs frequency hopping, and provides RF power amplification for output to the Transmitter's antenna.

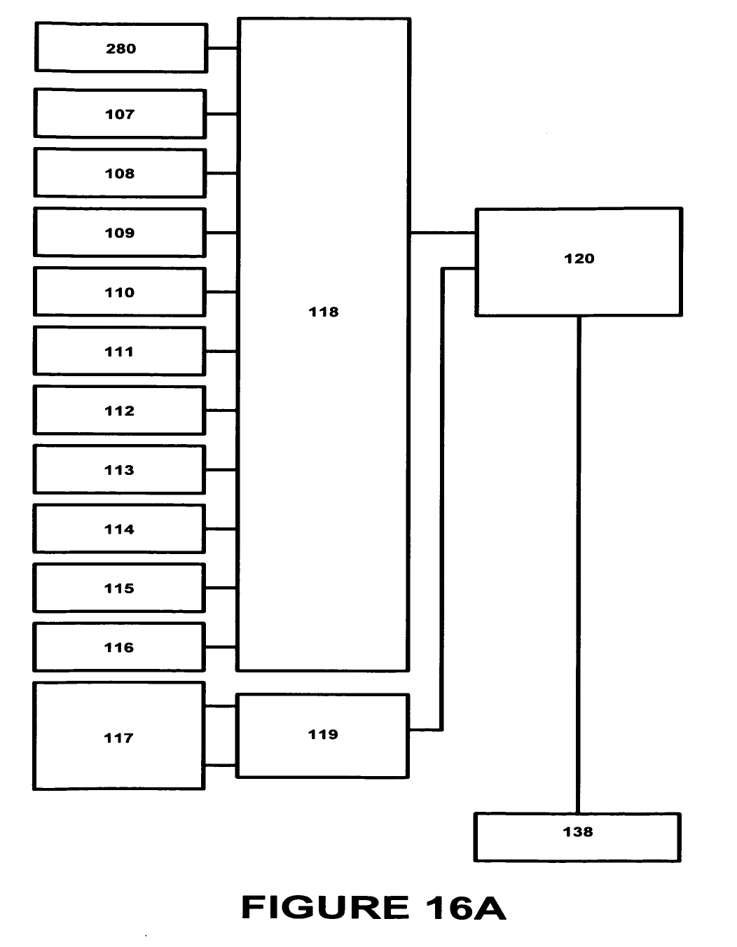

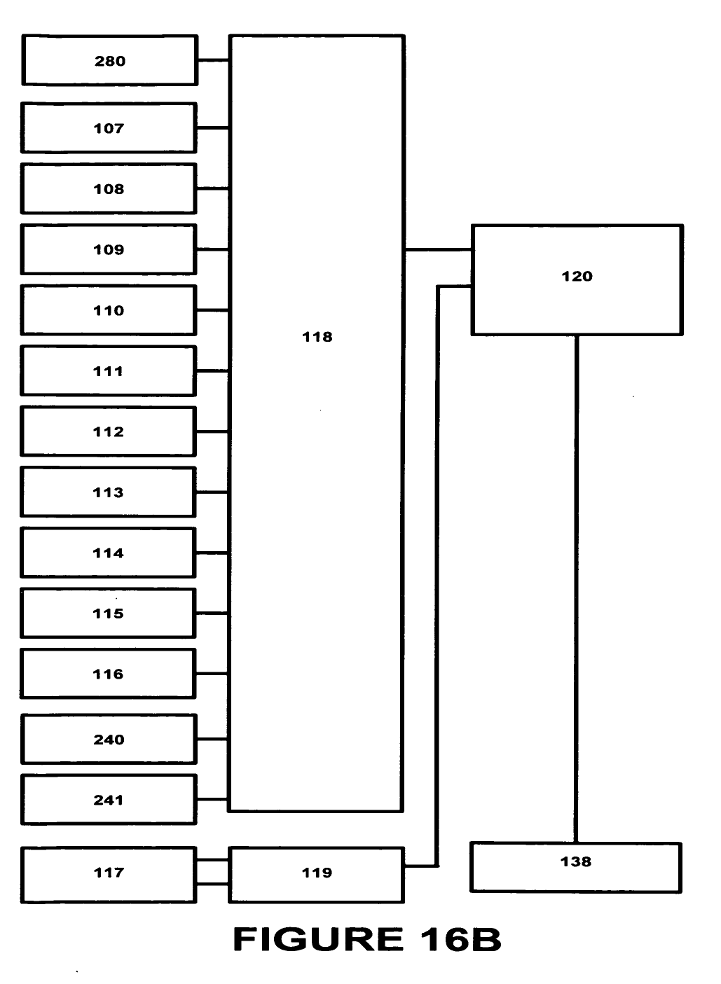

FIG. 16a for the obese version of the apparatus, a wired version of the apparatus switch input units 107 . . . 117 and 280, (2) Encoder unit 118, (3) Joystick input unit 117, (4) 2 Channel A/D Converter unit 119, (5) Combiner unit 120, processed data is sent to the input/output interface unit 138 for use by some other unit such as the microprocessor 140 (not shown).

FIG. 16b for the extreme large obese version of the apparatus, a wired version of the apparatus switch input units 107 . . . 117, 240, 241 and 280, (2) Encoder unit 118, (3) Joystick input unit 117, (4) 2 Channel A/D Converter unit 119, (5) Combiner unit 120, processed data is sent to the input/output interface unit 138 for use by some other unit such as the microprocessor 140 (not shown).

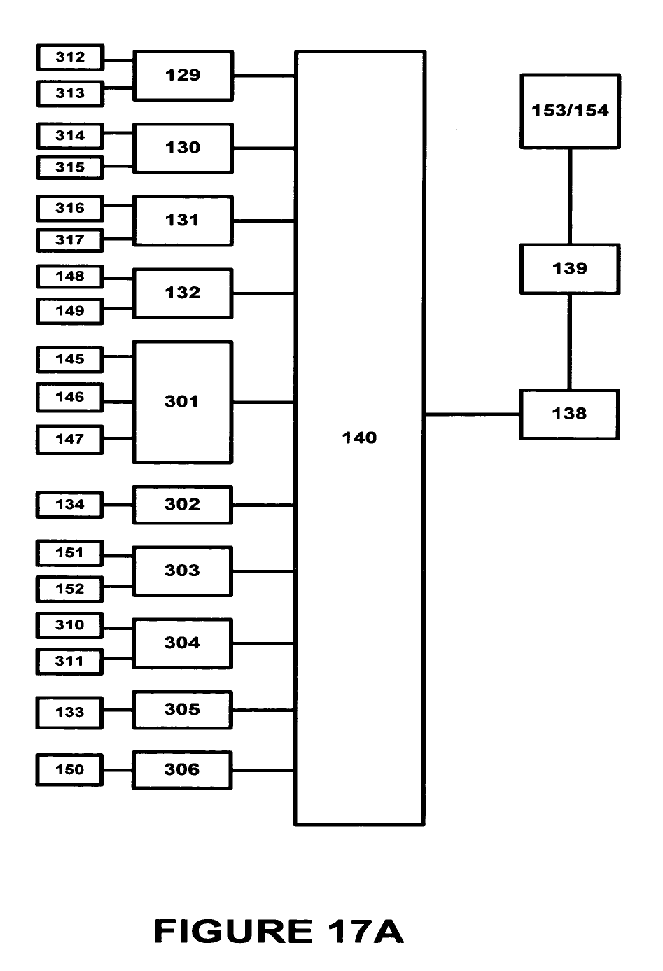

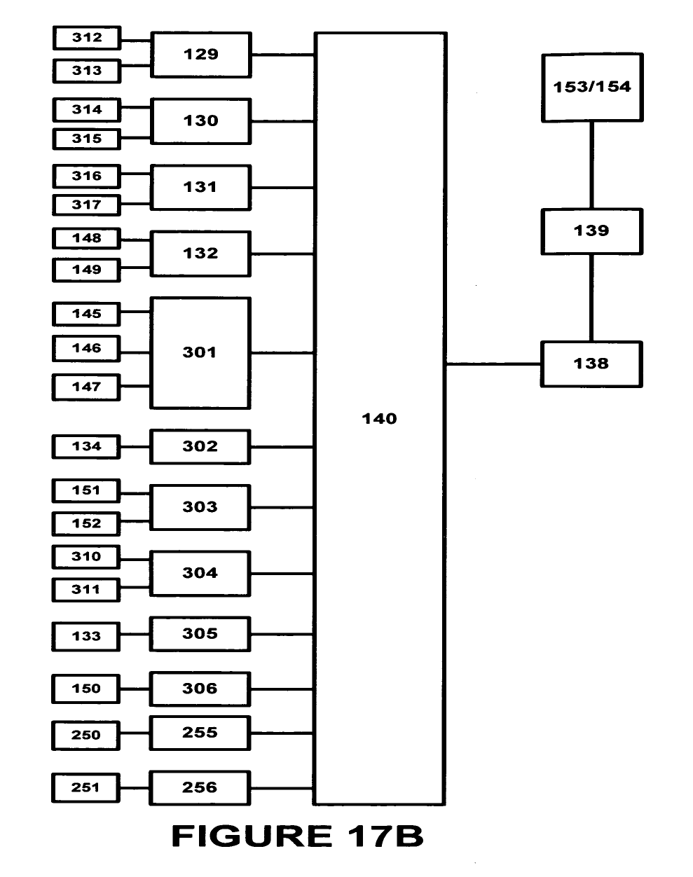

In FIG. 17a shows a block diagram of the electronic configuration for the obese version of the invention. It has a receiver unit 153 or 154 depending if the wireless data is sent by IR or RF. For the IR mode, which includes a light detector unit 153, (2) Receiver processor unit 139, and (4) Input/output interface unit 138. The receiver light detector unit 153 detects light energy, and the output is sent to the receiver processor unit 139 to be analyzed for a predetermined time period to detect presence of data and correct the data from any errors that might have been introduced during the transmission of the data. The processed data is sent to the input/output interface unit 138 for use by microprocessor unit 140 or by the remote computer unit 501 (not shown). For the RF mode, the RF receiver unit 154 accepts RF energy inputs, rejects signals not of interest, down-converts, dehops, amplifies, filters, phase detects, and digitizes the message for output to the signal processor unit 139. The signal processor performs preamble and message data processing, the data is analyzed for a predetermined time period to detect presence of data and correct the data from any errors that might have been introduced during the transmission of the data. The processed data is sent to the input/output interface unit 138 for use by some other unit such as the microprocessor 140 or by the remote computer 501 (not shown). The microprocessor 140 has a executable program that directs the functions of the RF receiver 154. This program provides control of the RF receiver unit 154, processing of data packets for reception, input data from switch(s)/joystick activation(s), system time, and built-in test and fault detection. The Microprocessor unit 140 controls the various motors within the apparatus. Programmable rheostat units 129, 130, 131,132, 301, 302, 303, 304, 305 and 306 control the speed and direction of reversible DC motor units 133, 134, 145, 146, 147, 148, 149, 150, 151, 152, 310, 311, 312, 313, 314, 315, 316 and 317. Motor units 145, 146 and 147 are used for Stability Fin units A, B and C; drive wheel motor unit 151 provides for speed of the apparatus and drive wheel motor unit 152 provides the drive for steering of the apparatus. Chin/head support movement is controlled by motor unit 134, upper trunk movement by motor unit 133, winch motor unit 155, lift arm A motor unit 312 and lift arm B motor unit 313, extender rod A motor unit 316 and extender rod B motor unit 317, and rotate lift arm A motor unit 312 and rotate lift arm B motor unit 313. Knee pads are controlled by drive motor units 148 and 149 and side panel units are controlled by drive motor units 310 and 311. Drive motor unit 150 controls support platform unit 271.

In FIG. 17b shows a block diagram of the electronic configuration for the extremely large obese version of the apparatus. It has a receiver unit 153 or 154 depending if the wireless data is sent by IR or RF. For the IR mode, which includes a light detector unit 153, (2) Receiver processor unit 139, and (4) Input/output interface unit 138. The receiver light detector unit 153 detects light energy, and the output is sent to the receiver processor unit 139 to be analyzed for a predetermined time period to detect presence of data and correct the data from any errors that might have been introduced during the transmission of the data. The processed data is sent to the input/output interface unit 138 for use by microprocessor unit 140 or by the remote computer unit 501 (not shown). For the RF mode, the RF receiver unit 154 accepts RF energy inputs, rejects signals not of interest, down-converts, dehops, amplifies, filters, phase detects, and digitizes the message for output to the signal processor unit 139. The signal processor performs preamble and message data processing, the data is analyzed for a predetermined time period to detect presence of data and correct the data from any errors that might have been introduced during the transmission of the data. The processed data is sent to the input/output interface unit 138 for use by some other unit such as the microprocessor 140 or by the remote computer 501 (not shown). The microprocessor 140 has a executable program that directs the functions of the RF receiver 154. This program provides control of the RF receiver unit 154, processing of data packets for reception, input data from switch(s)/joystick activation(s), system time, and built-in test and fault detection. The Microprocessor unit 140 controls the various motors within the apparatus. Programmable rheostat units 129, 130, 131,132, 255, 256, 301, 302, 303, 304, 305 and 306 control the speed and direction of reversible DC motor units 133, 134, 145, 146, 147, 148, 149, 150, 151, 152, 255, 256, 310, 311, 312, 313, 314, 315, 316 and 317. Motor units 145, 146 and 147 are used for Stability Fin units A, B and C; drive wheel motor unit 151 provides for speed of the apparatus and drive wheel motor unit 152 provides the drive for steering of the apparatus. Chin/head support movement is controlled by motor unit 134, upper trunk movement by motor unit 133, winch motor unit 155, lift arm A motor unit 312 and lift arm B motor unit 313, extender rod A motor unit 316 and extender rod B motor unit 317, and rotate lift arm A motor unit 312 and rotate lift arm B motor unit 313. Knee pads are controlled by drive motor units 148 and 149 and side panel units are controlled by drive motor units 310 and 311. Drive motor unit 150 controls support platform unit 271. Sling seat unit 220 is engaged by drive motor unit 250 and lower/raised by drive motor unit 251.

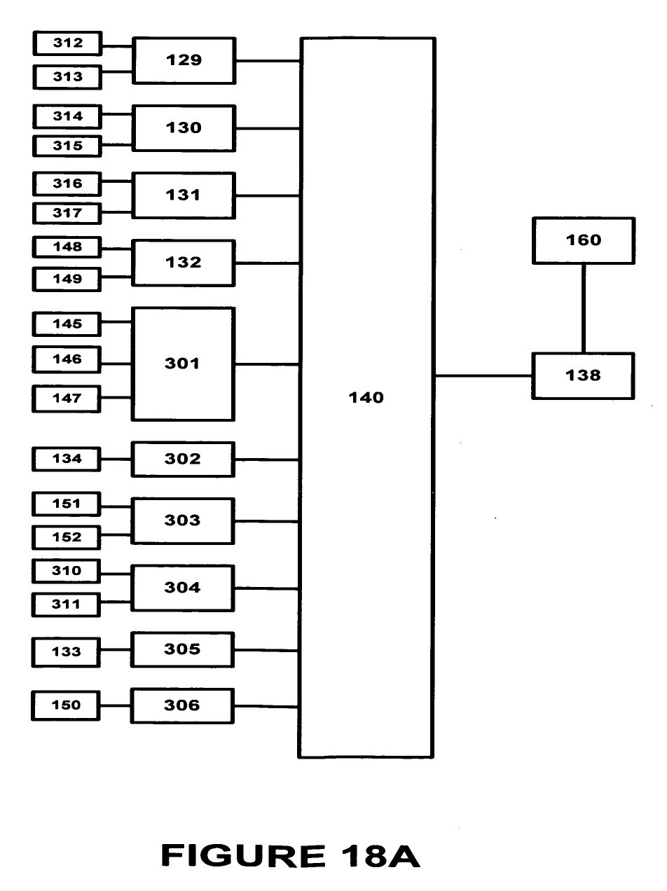

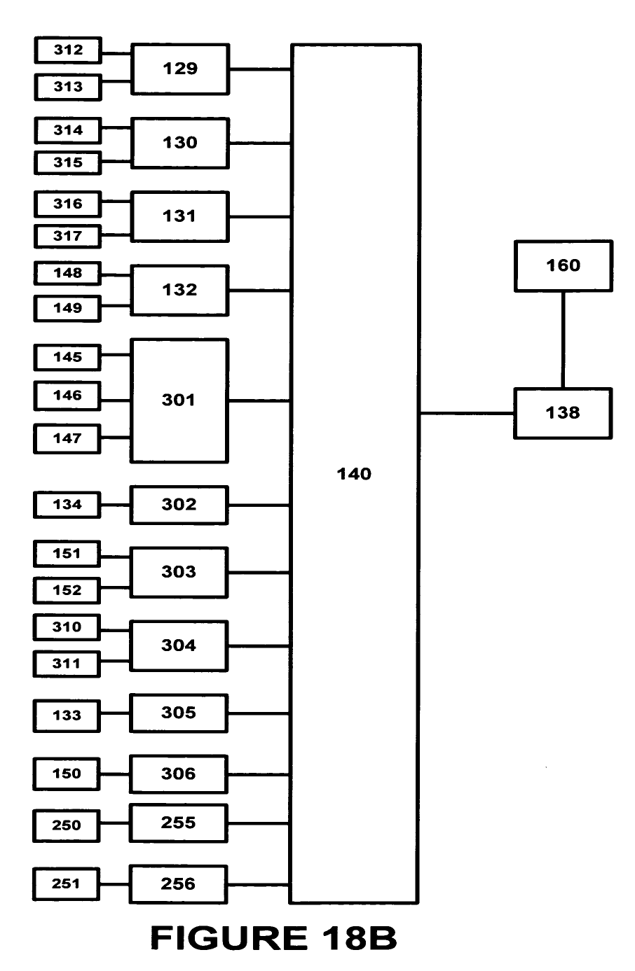

FIG. 18a shows a block diagram of the electronic configuration in the wired of the invention for the obese version. The processed data is sent to the input/output interface unit 138 for use by microprocessor unit 140 or by the remote computer unit 501 (not shown). The Microprocessor 140 controls the various motors within the invention. The Microprocessor unit 140 controls the various motors within the apparatus. Programmable rheostat units 129, 130, 131,132, 301, 302, 303, 304, 305 and 306 control the speed and direction of reversible DC motor units 133, 134, 145, 146, 147, 148, 149, 150, 151, 152, 310, 311, 312, 313, 314, 315, 316 and 317. Motor units 145, 146 and 147 are used for Stability Fin units A, B and C; drive wheel motor unit 151 provides for speed of the apparatus and drive wheel motor unit 152 provides the drive for steering of the apparatus. Chin/head support movement is controlled by motor unit 134, upper trunk movement by motor unit 133, winch motor unit 155, lift arm A motor unit 312 and lift arm B motor unit 313, extender rod A motor unit 316 and extender rod B motor unit 317, and rotate lift arm A motor unit 312 and rotate lift arm B motor unit 313. Knee pads are controlled by drive motor units 148 and 149 and side panel units are controlled by drive motor units 310 and 311. Drive motor unit 150 controls support platform unit 271.

FIG. 18b shows a block diagram of the electronic configuration in the wired of the invention for the extremely large obese version. The processed data is sent to the input/output interface unit 138 for use by microprocessor unit 140 or by the remote computer unit 501 (not shown). The Microprocessor 140 controls the various motors within the apparatus. Programmable rheostat units 129, 130, 131,132, 255, 256, 301, 302, 303, 304, 305 and 306 control the speed and direction of reversible DC motor units 133, 134, 145, 146, 147, 148, 149, 150, 151, 152, 255, 256, 310, 311, 312, 313, 314, 315, 316 and 317. Motor units 145, 146 and 147 are used for Stability Fin units A, B and C; drive wheel motor unit 151 provides for speed of the apparatus and drive wheel motor unit 152 provides the drive for steering of the apparatus. Chin/head support movement is controlled by motor unit 134, upper trunk movement by motor unit 133, winch motor unit 155, lift arm A motor unit 312 and lift arm B motor unit 313, extender rod A motor unit 316 and extender rod B motor unit 317, and rotate lift arm A motor unit 312 and rotate lift arm B motor unit 313. Knee pads are controlled by drive motor units 148 and 149 and side panel units are controlled by drive motor units 310 and 311. Drive motor unit 150 controls support platform unit 271. Sling seat unit 220 is engaged by drive motor unit 250 and lower/raised by drive motor unit 251.

All RF and IR transmissions are subject to noise, interference and fading. Most short-range RF and IR wireless data communications use some form of packet protocol to automatically assure information is received correctly at the correct destination. A packet generally includes a preamble, a start symbol, routing instruct, packet ID, message segment, error correct bits, and other information (if required). Various correction schemes can be employed to minimize transmission errors. To counter this effect or areas were where wireless transmissions are forbidden a wired configuration is implemented in the invention.

In describing the invention, reference has been made to a preferred embodiment and illustrative advantages of the invention. Those skilled in the art, however, and familiar with the instant disclosure of the subject invention, may recognize that numerous other modifications, variations, and adaptations may be made without departing from the scope of the invention. With these modifications, variations and adaptations can be applied to the various units within the apparatus.

1. Apparatus for assisting in movement of an individual from one position to a second position at a first location, and for relocating said individual while in the latter position to a second location comprising:
a housing having a base, said housing during assisting movement of said individual disposed in substantially a vertical orientation along an axis extending from said base toward an upper region;
said base has an embedded retractable platform for support and stability of the user during transition from seating to standing and standing to seating orientation;
a lower housing, said lower housing having a throne shaped cavity space embedded within said lower housing;
said lower housing having an embedded seat within said lower housing, but not included in cavity space;
a plurality of stability fins for support of said housing in said orientation over a surface and for maintaining said positioning during movement of said housing along said surface to any one of a number of indeterminate locations;
first means carried by said housing for mounting each said stability fin on said housing;
a support providing an engaging surface for supporting the feet of said individual in each of said positions;
a mechanized method for extending/retracting said stability fin on said housing by telescoping means;
a mechanized method for extending/retracting said stability fin on said housing by mechanical linkage;
a method for extending/retracting said stability fin on said housing by pivotal means;
second means for mounting said support near said base;
first and second lifting arms, said first lifting arm disposed on one side of said upper housing remote from said base, and said second lifting arm disposed substantially opposite to other side of said housing similarly remote from said base;
a handle carried by each said lifting arm adapted to be gripped by said individual during stages of relocating movement; and
extender unit supported by said housing and in turn supporting said first and second lifting arm, said extender unit means including controlling means for locating the disposition of each said lifting arm and handle to any position within a three-dimensional orientation relative to said individual being assisted in movement.

2. The apparatus of claim 1 wherein said housing comprises an upper portion, a lower portion, base portion and extension portion.

3. The apparatus of claim 2 further comprising a winch holder unit contained in said upper portion and said winch holder unit comprising a reel mechanism and a hook and line adapted for attachment to a harness capable of receipt around the individual's torso, said reel mechanism operated for retrieving said line and drawing on said harness for further assist in relocating said individual to said second position; and means for mounting said winch holder unit within said upper portion of said housing.

4. The apparatus of claim 2 further comprising means for mounting said upper and lower portion in fixed operative positions for use of said apparatus, and for movement telescopically of said upper portion into said lower portion defining an inoperative condition of said apparatus, as well as returning movement of said upper portion to their extended, fixed operative positions.

5. The apparatus of claim 1 wherein said stability fins are arranged substantially equidistantly around said axis of said housing, each said stability fin including a first member extending in an outward and downward orientation from a first end to a second, remote end, a wheel, and means at said remote end for mounting said wheel to said first member for rolling movement.

6. The apparatus of claim 5 wherein each stability fin in addition includes a second member extending in an outward orientation from a first end to a second, remote end, said means also connecting said remote end of said second member to said remote end of said first member, and means connecting said first end of said first and second members to said housing.

7. The apparatus of claim 6 wherein said first and second member of each stability fin includes a plurality of individual sub members, and means supporting each sub member of each stability fin in a manner that the sub members from said remote end may be telescopically received within the next adjacent sub member toward said first end whereby said first and second members of a stability fin may be both reduced in length and returned to any extended radial length required to satisfy requirements for support of said individual in relocating said individual to said second location.

8. The apparatus of claim 7 wherein said sub members of each stability fin are of substantially equal length.

9. The apparatus of claim 7 further including an opening in a surface of said lower portion, a fixed plate located within said housing near said opening, and means mounting said first and second members on said fixed plate during telescoping movement and for pivotal movement from said supporting position within said opening.

10. The apparatus of claim 7 wherein said stability fins include three sub members.

11. The apparatus of claim 2 comprising a pair of knee pad units, and means carried by said housing within said lower portion for mounting each knee pad units, said ninth means mounting said knee pad units for movement within a plane to an indeterminate number of dispositions according to the physical dimensions and weight of said individual.

12. The apparatus of claim 11 wherein said means includes a first and second plate, at least one slot in each plate, and a pin extending through said slots, flange means on opposite ends of said pin for support in and movement along said slots when said plates are disposed in position with the slot in one plate arranged perpendicular to said slot in said other plate.

13. The apparatus of claim 2 further comprising a chest protector pad, means carried by said housing for mounting said chest protector pad on said middle portion.

14. The apparatus of claim 1 wherein said controlling means includes a pair of controlling rods located in substantially coaxial relation and extending radially of said axis, each lifting arm fixedly connected to a respective one of said controlling rods for movement to and between angular disposition following a first rotational movement input to each said controlling rod.

15. The apparatus of claim 1 wherein said controlling means includes a pair of controlling rods located in substantially coaxial relation and extending radially of said axis, a sleeve mounted coaxially on each controlling rod for rotational movement independently of any rotational movement of its support, a drive gear mounted on said sleeve, and said lifting arms each including a gear track along a surface facing said housing, each said drive gear cooperating in said gear track for movement of said lifting arms to and between linear dispositions toward and away from said individual.

16. The apparatus of claim 14 wherein said controlling rods support coaxially a drive gear mounted for rotational movement together with and/or independently of said first rotational movement, and said lifting arms each including a gear track along a surface facing said housing, each said drive gear cooperating in said gear track for movement of said lifting arms to and between linear dispositions toward and away from said individual.

17. The apparatus of claim 1 wherein said controlling means includes a pair of controlling rods located in substantially coaxial relation and extending radially of said axis, and further comprising means for extending and retracting said controlling means thereby to locate each said lifting arm in any one of an indeterminate number of positions laterally of said housing determined by the physical make-up of said individual.

18. The apparatus of claim 1 further including power source connected to each independent structure adapted to undergo movement for any or all necessities of assisting said individual, and control means for controlling each movement and the degree of movement determined by the physical specifications of said individual.

19. The apparatus of claim 18 further including remote means for controlling operation of said power source.

20. The apparatus of claim 5 further including sensors disposed around said wheels to detect obstacles and when activated an alarm is initiated to alert said operator of the said apparatus.

21. The apparatus of claim 1 further including removable liner connected to throne shaped cavity that is cleanable for sanitary usage of the said apparatus.
